(19) United States
(12) Patent Application Publication
(10) Pub. No.: US 2025/0342323 A1
(43) Pub. Date: Nov. 6, 2025

(54) SECURITY SYSTEM FOR GENERATING ARTIFICIAL INTELLIGENCE (AI) INSIGHTS ABOUT SECURITY ALERTS

(71) Applicant: Elastic Technologies (US) Inc., San Francisco, CA (US)

(72) Inventors: James Spiteri, Parker, CO (US); Andrew Macri, Carmel, NY (US); Pedro Jaramillo, Bonney Lake, WA (US)

(21) Appl. No.: 19/200,370

(22) Filed: May 6, 2025

Related U.S. Application Data
(60) Provisional application No. 63/643,302, filed on May 6, 2024.

(51) Int. Cl. G06F 40/40; G06F 40/103; G06F 40/279

(52) U.S. Cl. CPC G06F 40/40; G06F 40/103; G06F 40/279

(57) ABSTRACT

A security system may receive, without a submission of a user query, a model response from a large language model, where the model response includes structured data generated by the large language model using a plurality of security alerts. A security system may render an interface on a computing device using the structured data, where the interface displays information about a security insight event detected by the large language model using the plurality of security alerts, and the interface identifies a portion of the plurality of security alerts as related to the security insight event.

### CROSS REFERENCE TO RELATED APPLICATION

This application claims priority to U.S. Provisional Application No. 63/643,302, filed May 6, 2024, the entire content of which is herein incorporated by reference in its entirety.

### BACKGROUND

A security system may monitor and protect a computing system associated with one or more organizations. The security system may generate an alert when suspicious activity is detected on the computing system. According to some conventional approaches, the security system may provide an interface with the alerts, and a security researcher may use the interface to manually investigate individual alerts, which can be time consuming and cumbersome.

### SUMMARY

This disclosure relates to a security system with an artificial intelligent (AI) insight engine (e.g., an attack discovery engine) configured to operate with one or more large language models (LLMs) to initiate an analysis of security alerts and generation of a model response with one or more security insight events (e.g., sometimes referred to as AI generated insights or AI attack discoveries) about the security alerts. The model response is used by an application on a client device to render an insight interface with generative AI insights about the security alerts. The generation of the model response may be initiated without user prompting (e.g., receipt of a user query formulated by a user).

A security insight event may be a potential active attack event, and each security insight event includes structured data that is used to render at least a portion of an insight interface on a computing device. In some examples, a security insight event may be referred to as an attack discovery event. In some examples, the term insight (or AI insight) may be replaced with attack discovery or AI attack discovery. In some examples, the structured data includes a JavaScript Object Notation (JSON) format. The structured data defines a plurality of UI components in the insight interface and defines which security event information is used in each UI component. The insight interface displays security event information (e.g., a summary section, a detail section, an attack chain graphic, etc.) about a respective security insight event in the appropriate UI components. A security insight event may be referred to as a computer object defining a UI object with sections, selectable elements, visual images (e.g., attack chain graphic) and/or action items. An example of a security insight event may be a malware infection via a malicious office document. Using the security alerts, an LLM may generate one or more security insight events from the security alerts, identify which security alert(s) is/are related to a respective security insight event, and provide security event information (e.g., a summary section, a details section, an attack chain graphic, etc.) about a respective security insight event. The LLM may generate a security insight event based on trends and patterns associated with security alerts.

In some examples, the AI insight engine may be configured to communicate with a plurality of LLMs, which can be selected by the user. For example, a user may use one LLM to generate AI insights (e.g., security insight events) based on the security alerts retrieved from a database, and then switch to connect to another LLM to generate another set of AI insights.

In some aspects, the techniques described herein relate to a method including: receiving, without a submission of a user query, a model response from a large language model, the model response including structured data generated by the large language model using a plurality of security alerts; and rendering an interface on a computing device using the structured data, the interface displaying information about a security insight event detected by the large language model using the plurality of security alerts, the interface identifying a portion of the plurality of security alerts as related to the security insight event.

In some aspects, the techniques described herein relate to an apparatus including: at least one processor; and a non-transitory computer-readable medium storing executable instructions that cause the at least one processor to execute operations, the operations including: receiving, without a submission of a user query, a model response from a large language model, the model response including structured data generated by the large language model using a plurality of security alerts; and rendering an interface on a computing device using the structured data, the interface displaying information about a security insight event detected by the large language model using the plurality of security alerts, the security insight event being a potential active attack on a monitored computing system, the interface identifying a portion of the plurality of security alerts as related to the security insight event.

In some aspects, the techniques described herein relate to a non-transitory computer-readable medium storing executable instructions that when executed by at least one processor cause the at least one processor to execute operations, the operations including: receiving, without a submission of a user query, a model response from a large language model, the model response including structured data generated by the large language model using a plurality of security alerts; and rendering an interface on a computing device using the structured data, the interface displaying information about a security insight event detected by the large language model using the plurality of security alerts, the security insight event being a potential active attack on a monitored computing system, the interface identifying a portion of the plurality of security alerts as related to the security insight event.

In some aspects, the techniques described herein relate to a method including: retrieving a plurality of security alerts from a database; transmitting a prompt to a large language model, the prompt including formatting instructions and the plurality of security alerts; receiving a model response from the large language model, the model response including structured data configured to render an interface, the structured data including information about a security insight event detected by the large language model using the plurality of security alerts, the structured data identifying a portion of the plurality of security alerts as related to the security insight event; and transmitting the model response to application, the model response being to cause the application to render the interface.

In some aspects, the techniques described herein relate to an apparatus including: at least one processor; and a non-transitory computer-readable medium storing executable instructions that cause the at least one processor to execute operations, the operations including: retrieving a plurality of security alerts from a database; transmitting a prompt to a large language model, the prompt including formatting instructions and the plurality of security alerts; receiving a model response from the large language model, the model response including structured data configured to render an interface, the structured data including information about a security insight event detected by the large language model using the plurality of security alerts, the structured data identifying a portion of the plurality of security alerts as related to the security insight event; and transmitting the model response to application, the model response being to cause the application to render the interface.

In some aspects, the techniques described herein relate to a non-transitory computer-readable medium storing executable instructions that when executed by at least one processor cause the at least one processor to execute operations, the operations further including: retrieving a plurality of security alerts from a database; transmitting a prompt to a large language model, the prompt including formatting instructions and the plurality of security alerts; receiving a model response from the large language model, the model response including structured data configured to render an interface, the structured data including information about a security insight event detected by the large language model using the plurality of security alerts, the structured data identifying a portion of the plurality of security alerts as related to the security insight event; and transmitting the model response to application, the model response being to cause the application to render the interface.

In some aspects, the techniques described herein relate to a method including: initiating display of a user interface, the user interface identifying a first identifier of a first large language model (LLM) and a second identifier of a second LLM; receiving a selection of the first LLM; initiating generation of a first model response by the first LLM, the first model response including structured data about at least one first security insight event generated by the first LLM using a plurality of security alerts; storing the at least one first security insight event in a storage device; and rendering an interface based on the first model response, the interface displaying the at least one first security insight event.

In some aspects, the techniques described herein relate to an apparatus including: at least one processor; and a non-transitory computer-readable medium storing executable instructions that cause the at least one processor to execute operations, the operations including: initiating display of a user interface, the user interface identifying a first identifier of a first large language model (LLM) and a second identifier of a second LLM; receiving a selection of the first LLM; initiating generation of a first model response by the first LLM, the first model response including structured data about at least one first security insight event generated by the first LLM using a plurality of security alerts; storing the at least one first security insight event in a storage device; and rendering an interface based on the first model response, the interface displaying the at least one first security insight event.

In some aspects, the techniques described herein relate to a non-transitory computer-readable medium storing executable instructions that when executed by at least one processor cause the at least one processor to execute operations, the operations including: initiating display of a user interface, the user interface identifying a first identifier of a first large language model (LLM) and a second identifier of a second LLM; receiving a selection of the first LLM; initiating generation of a first model response by the first LLM, the first model response including structured data about at least one first security insight event generated by the first LLM using a plurality of security alerts; storing the at least one first security insight event in a storage device; and rendering an interface based on the first model response, the interface displaying the at least one first security insight event.

The details of one or more implementations are set forth in the accompanying drawings and the description below. Other features will be apparent from the description and drawings, and from the claims.

### BRIEF DESCRIPTION OF THE DRAWINGS

FIG. 1A illustrates a security system that integrates a large language model (LLM) for generating artificial intelligence (AI) insights (e.g., security insight event(s)) from security alerts according to an aspect.

FIG. 1B illustrates a security analytics platform that can operate with multiple LLMs according to an aspect.

FIG. 1C illustrates an example of a prompt according to an aspect.

FIG. 1D illustrates an example of a model response according to an aspect.

FIG. 1E illustrates an example of an insights interface according to an aspect.

FIG. 1F illustrates an example of identifying progression data for an attack chain graphic according to an aspect.

FIG. 1G illustrates various aspects of implementing other workflows from an insight interface according to an aspect.

FIG. 1H illustrates an example of switching between anonymized data and anonymized data for a security insight event according to an aspect.

FIG. 1I illustrates an example setting interface according to an aspect.

FIG. 1J illustrates an example of generating a prompt using custom knowledge data according to an aspect.

FIG. 1K illustrates an example of a security system according to an aspect.

FIGS. 2A through 19 illustrate various examples of interfaces provided by the security system.

FIG. 20 is a flowchart depicting example operations of a security system according to an aspect.

FIG. 21 is a flowchart depicting example operations of a security system according to another aspect.

FIG. 22 is a flowchart depicting example operations of a security system according to another aspect.

### DETAILED DESCRIPTION

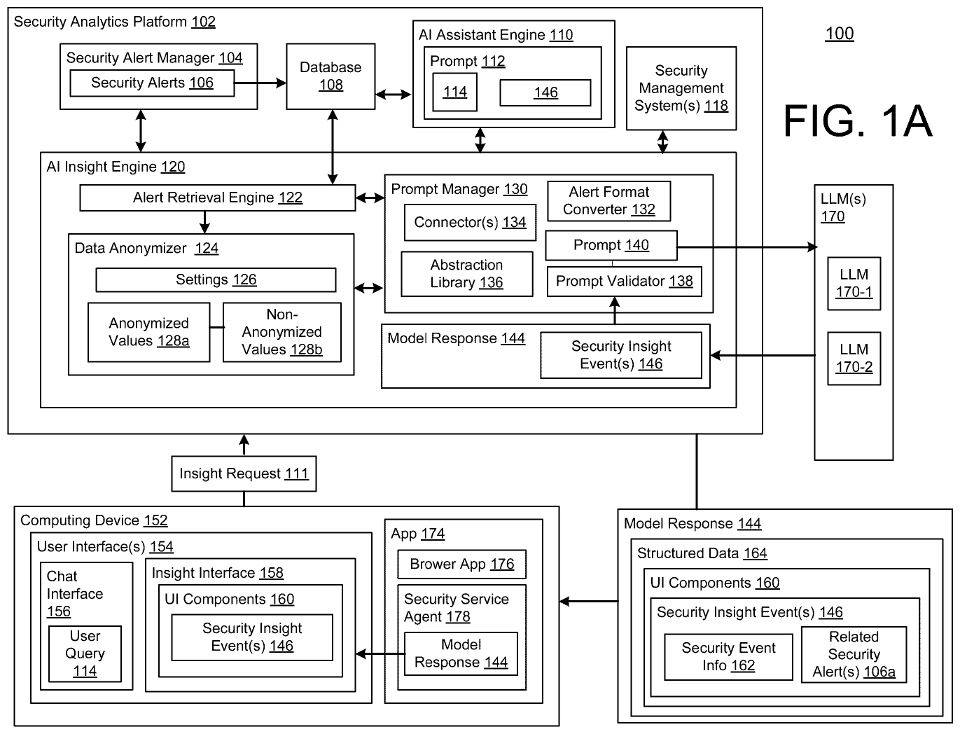

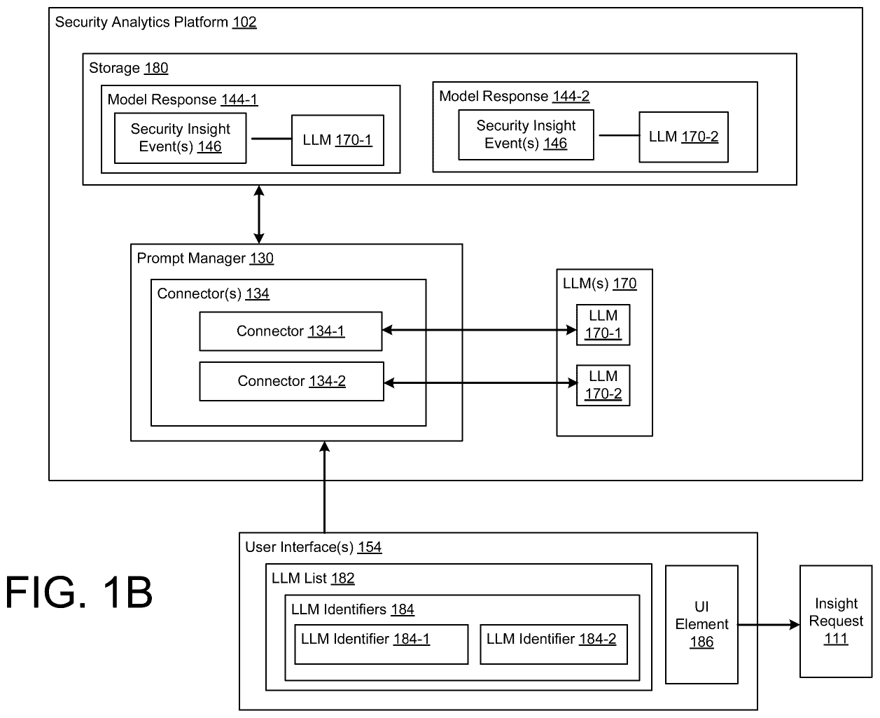

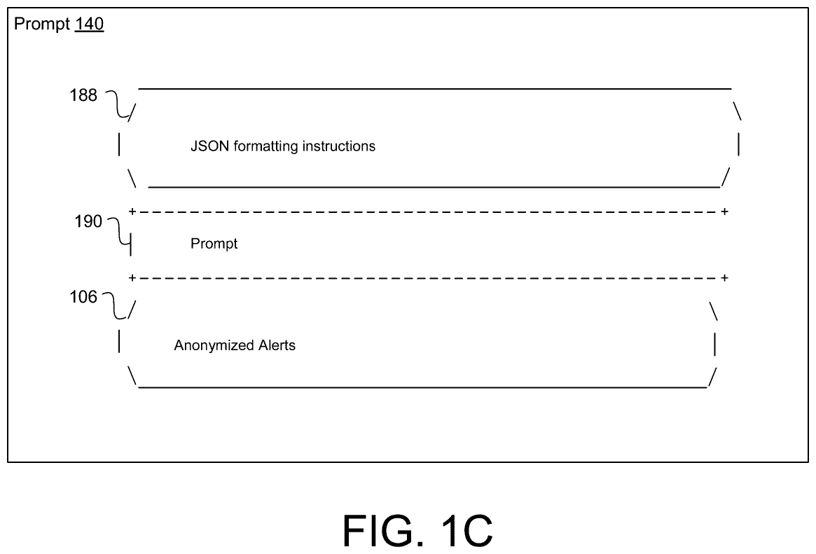

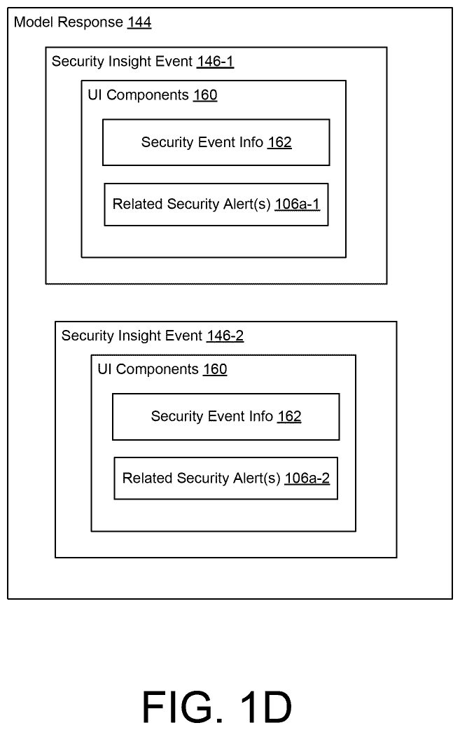

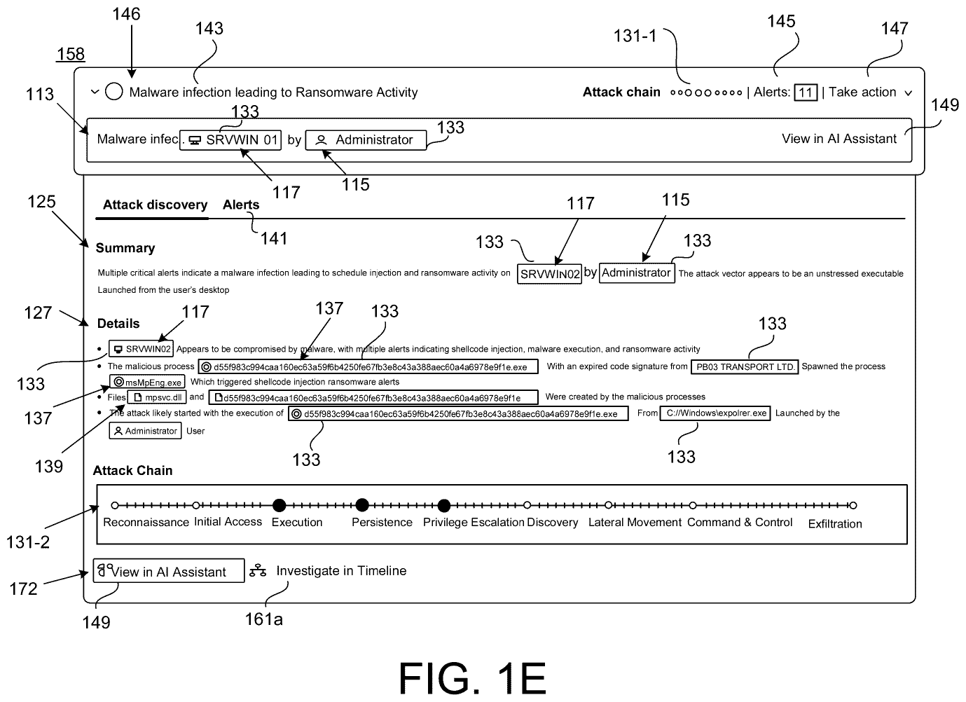

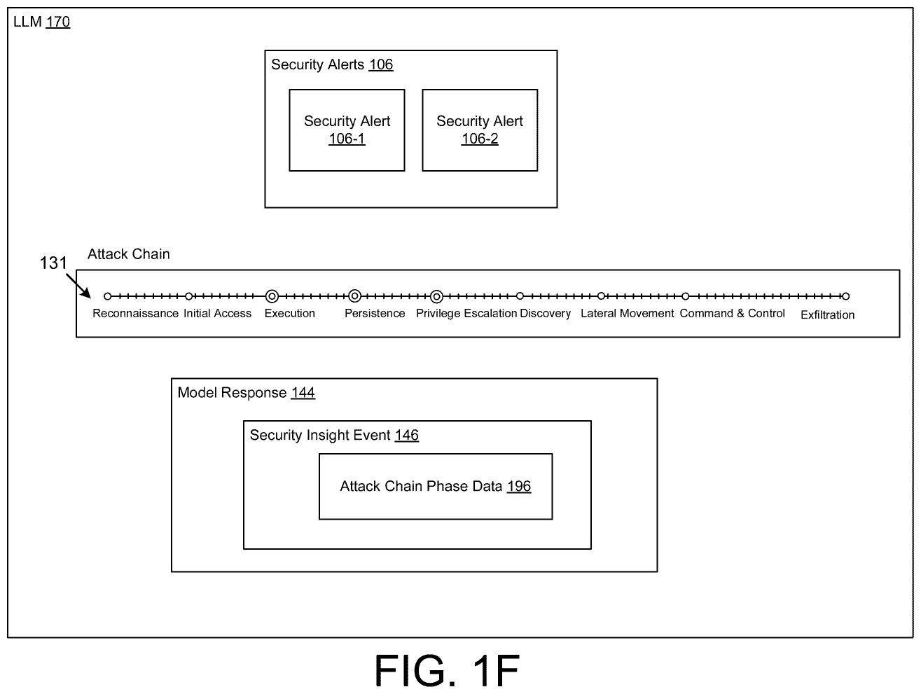

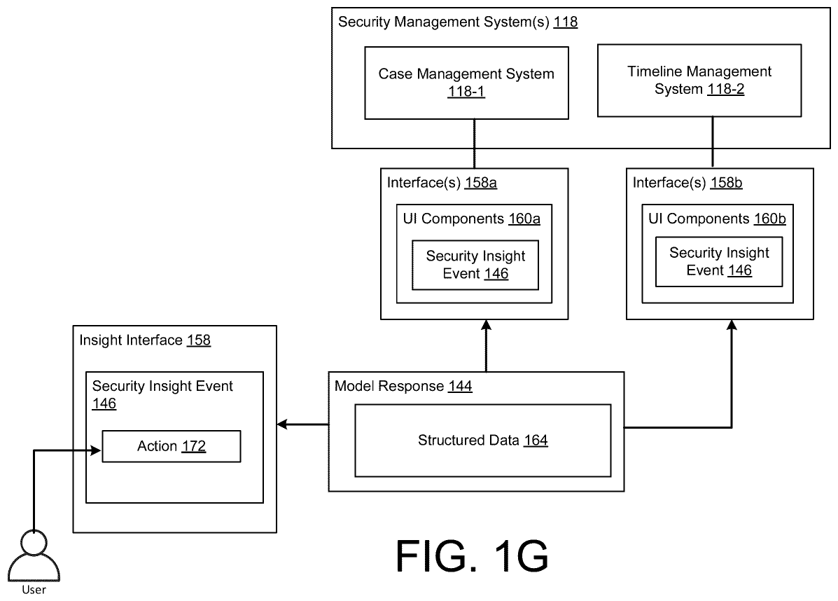

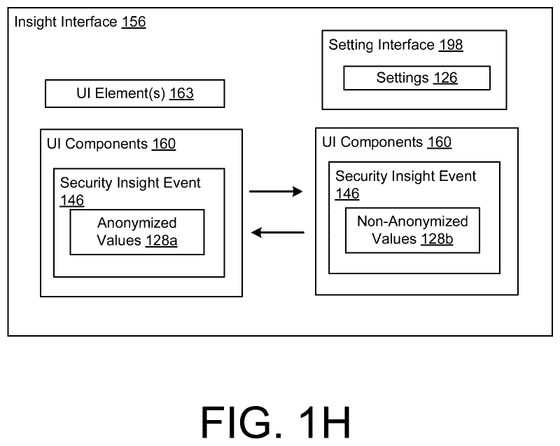

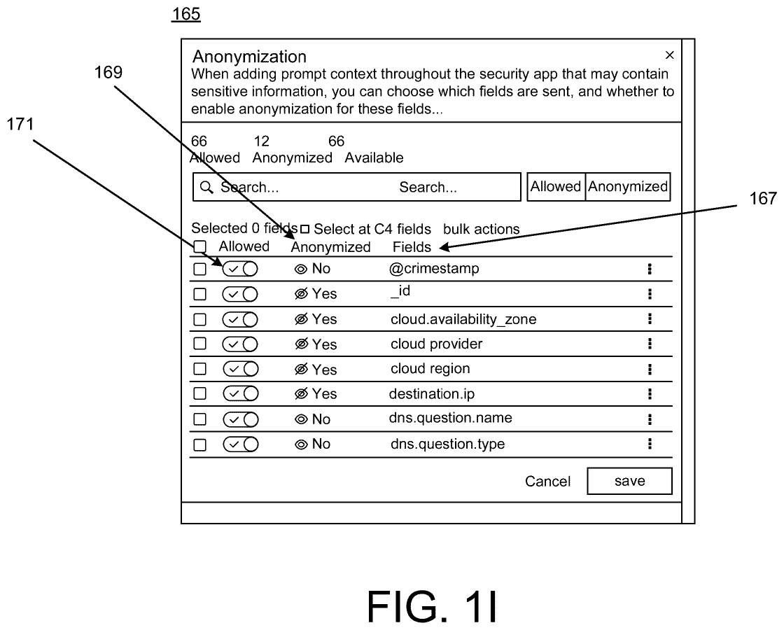

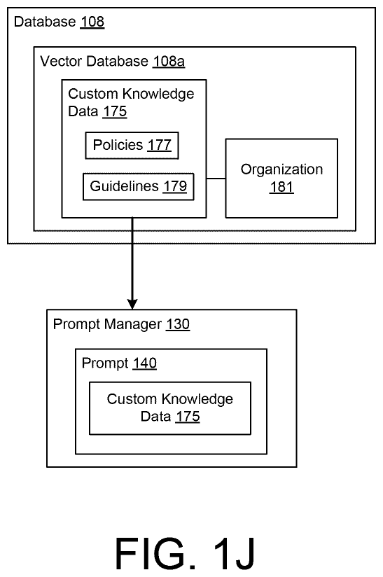

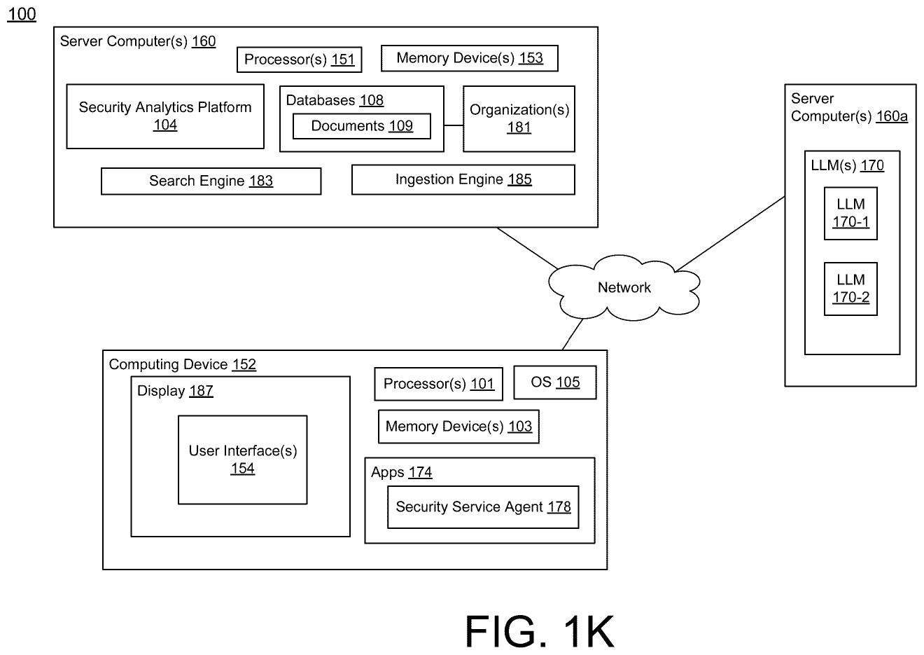

FIGS. 1A through 1K illustrate a security system 100 that includes a security analytics platform 102 having an artificial intelligence (AI) insight engine 120 configured to communicate with one or more large language model (LLMs) 170 to generate one or more security insight events 146 from security alerts 106 and to generate a model response 144 with structured data 164 about the security insight event(s) 146. In some examples, the security analytics platform 102 initiates the generation of the model response 144 without user prompting (e.g., without receiving a user query 114 formulated by a user).

The AI insight engine 120 is configured to perform a sophisticated technical analysis of a plurality of security alerts 106 retrieved from a database 108 to identify security insight events 146 that represent potential active attacks on a monitored computing system. This process goes beyond mere aggregation or presentation of information by employing a specifically crafted prompt 140 and leveraging the analytical capabilities of an LLM 170 to discern complex patterns and correlations within the alert data that would not be apparent through conventional security monitoring tools or manual human analysis. In some examples, the AI insight engine 120 may use an iterative process (e.g., a graphed approach) to identify security insight events 146 by communicating with the LLM 170 in a sequence of steps (e.g., action nodes of a generation graph), which may reduce the number of technical errors with processing such as a large volume of data and increase the performance (e.g., speed, accuracy) and the system. In some examples, identifying security insight events 146 using security alerts 106 refers to an attack discovery process.

The AI insight engine 120 is configured to technically construct the prompt(s) 140 to guide the LLM's analysis by formatting instructions that technically constrain the LLM's output to a structured data format 164, which is specifically designed for efficient parsing and rendering of a dynamic user interface. The structured output may ensure that the identified security insight events 146 and their associated information can be programmatically utilized by the application 174 to configure and populate specific UI components 160. Further, the AI insight engine 120 may construct the prompt(s) 140 to include detailed instructions on the technical methodology the LLM 170 should employ to analyze the security alerts 106. These instructions direct the LLM to identify subtle trends and complex patterns across seemingly disparate security alerts 106 that, when considered together, indicate a coordinated attack progression rather than isolated incidents. The attach generation process discussed herein may cause the LLM 170 to technically evaluate the relationships between different alerts, such as timing, affected entities (e.g., users, devices, processes, files, etc.), and types of activity, to construct a technical model of a potential attack chain graphic 131.

The constructed prompt(s) 140 may cause the LLM 170 to generate security event information 162, including a summary (e.g., summary section 125), detailed description (e.g., details section 127), and attack chain graphic data 196, which may involve the technical synthesis of relevant data points from the analyzed security alerts into a coherent and informative narrative and visual representation of the potential attack. The LLM's technical process, guided by the prompt 140, allows for the detection of security insight events 146 that represent potential active attacks that would be difficult or impossible for a human analyst to identify in a timely manner, especially within large volumes of security alerts 106. By analyzing the interdependencies and temporal sequences of alerts, the LLM 170 can technically predict or infer attack progression phases even when explicit indicators are absent in individual alerts. The structured data 164 produced by the LLM 170 is a direct technical output of this analytical process, enabling the system to automatically render a detailed and interactive interface 158 providing actionable insights into complex security threats. This technical approach may improve the efficiency and effectiveness of security monitoring by automatically identifying and presenting potential active attacks in a structured and understandable format, thereby reducing the time and expertise required for manual investigation and enabling a faster and more informed security response.

In some examples, the iterative, graphed approach for generating the structured data 164 breaks down the complex analysis task into smaller, manageable steps orchestrated by the execution of a directed graph of action nodes. This may allow for more targeted prompting of the LLM 170 and better management of its context window compared to attempting the entire analysis in a single large request. This technical approach can lead to more efficient use of LLM resources, potentially reducing computational costs and improving processing speed, which are technical benefits related to the system's operational efficiency.

In some examples, the security system 100 for enabling the generation of model responses 144 using private data (e.g., security alerts 106, database 108) stored in a vector database 108a in a manner that protects the privacy of the private data. The security system 100 enables an LLM 177 to use data (e.g., private data) to generate one or more model responses 144 that maintains the privacy of the data. In some examples, the AI insight engine 120 may inject private data (e.g., security alerts 106, context data from the database 108) in a prompt 140.

An application 174, executing on a computing device 152, may receive the model response 144, and use the model response 144 to render an insight interface 158 with user interface (UI) components 160 configured by (e.g., powered by) the structured data 164. The structured data 164 defines one or more security insight events 146. The insight interface 158 displays the security insights event(s) 146 in the insight interface 158. In some examples, a security insight event 146 may be referred to as a computer object defining a UI object (e.g., a collapsible and/or expandible UI card) with one or more sections (e.g., an entity summary object 113, a summary section 125, a details section 127, etc.), one or more selectable elements 133 relating to entities mended in the security insight event 146, visual images (e.g., attack chain graphic 131) and/or action items (e.g., elements 149, 161a, and/or any of the actions associated with element 149).

The security event information 162 (or referred to as information of the security insight event 146) may provide a summary (e.g., a summary section 125) of a security insight event 146, a detailed explanation (e.g., a details section 127) of the security insight event 146, and one or more visual images (e.g., an attack chain graphic 131) associated with a security insight event 146. The insight interface 158 may include selectable elements 133 associated with entities (e.g., user identifiers, device identifiers, process identifiers, and/or file identifiers) mentioned in the security event information 162.

Selection of a selectable element 133 may cause the application 174 to render an entity interface (e.g., entity page) with information about the underlying entity. The insight interface 158 may include one or more selectable action elements (also referred to as action items or selectable action items), which, when selected, initiates a separate UI workflow relating to other security management systems 118 and/or other components provided by a security analytics platform 102. The security analytics platform 102 may cause the transfer of at least some of the information included in the security insight event 146 into the appropriate UI components 160 associated with the other security management systems 118 and/or other components provided by a security analytics platform 102.

In some examples, a user may cause the display of a chat interface 156 associated with an AI assistant engine 110 that communicates with an LLM 170 to respond to user queries 114. The AI assistant engine 110 may operate with a LLM 170 to assist a user with tasks like writing queries, understanding security alerts 106, and/or troubleshooting issues. In some examples, the insight interface 158 includes a selectable action element, which, when selected, causes the display of a chat interface 156 to enable the user to submit user queries 114. In some examples, the AI insight engine 120 may insert information from a selected security insight event 146 into a prompt 112 as context for the user query 114. For example, the prompt 112 may include the user query 114 and information from the security insight event 146.

The application 174 may use the model response 144 to render the insight interface 158, including the UI components 160 such as the selectable elements 133, the selectable action elements, the visual images (e.g., an attack chain graphic 131), and the information (e.g., the security event information 162) that populates the UI components 160. In some examples, the insight interface 158 is rendered solely from the structured data 164 of the model response 144. In some examples, the insight interface 158 is rendered in part from the structured data 164 of the model response 144.

The AI insight engine 120 operates with an LLM 170 to identify active attacks in the computing system, without the time (or prior experience) required to manually investigate individual security alerts 106. In some examples, the LLM 170 is referred to as a generative model. In some examples, the LLM 170 is referred to as a model. In some examples, an AI insight engine 120 may be referred to as an attack discovery engine. The AI insight engine 120 may identify whether one or more of the security alerts 106 are related, and, in some examples, the AI insight engine 120 may document the identified attack progression.

The security analytics platform 102 includes a security alert manager 104 that receives security alerts 106 from devices, applications, or system components of a computing system (e.g., a monitored computing system). A security alert 106 may be generated in response to computer activity being determined as suspicious activity. Types of security alerts 106 may include unauthorized access, suspicious activity, malware detection, system vulnerabilities, denial-of-service attacks, and/or security policy violations. A security alert 106 may include information about the security alert 106 such as the source(s) (e.g., the affected device identifier(s) 117 and/or user identifier 115), the type or name of security alert 106, time information of when a security alert 106 was generated, severity of the security alert 106, and/or other information such as specific log entries, file names, IP addresses, or/or error messages. The security alert manager 104 may store the security alerts 106 in a database 108.

A computing device 152 includes an application 174 configured to render one or more user interfaces 154 associated with the security analytics platform 102. The user interface(s) 154 enables a security user to view, search, manage and/or perform action(s) with respect to the security alerts 106. In some examples, the application 174 is a browser application 176, and the user interface(s) 154 are web page(s) of the security analytics platform 102. In some examples, the application 174 includes a security service agent 178 configured to enable the application 174 and the security analytics platform 102 to communicate with each. In some examples, the security service agent 178 is an extension, a web application, or a plug-in.

To initiate generation of a model response 144, the AI insight engine 120 may communicate with a large language model 170. In some examples, the AI insight engine 120 is configured to communicate with one or more LLMs 170. For example, instead of integrating a single LLM 170 in the security analytics platforms 102, the AI insight engine 120 may be configured to operate with a plurality of different LLMs 170. In some examples, the AI insight engine 120 includes connectors 134 and an abstraction library 136. A connector 134 may be a computer object that is stored at the security analytics platform 102 and includes information that enables the AI insight engine 120 to communicate with a corresponding LLM 170 (e.g., transmit a prompt 140, receive a model response 144). The abstraction library 136 may define a library that generates a prompt 140 with a generic format that may be used by any of the LLMs 170 with connectors 134 stored at the security analytics platform 102. The use of the connectors 134 and/or the abstraction library 136 may enable the AI insight engine 120 to be agnostic to a plurality of LLMs 170. Although two LLMs 170 (e.g., LLM 170-1, LLM 170-2) are depicted in FIGS. 1A and 1B, the AI insight engine 120 may be configured to operate with any number of LLMs 170, including three, four, five, or any number greater than five.

The techniques discussed herein provide the user freedom to use a variety of different LLMs 170, as well as the ability to pivot between multiple LLMs 170 models at any point in time, which may provide improvements in cost control, speed, and/or privacy. For example, the LLM 170 that is used to generate the model response 144 may be selected by the user. For example, as shown in FIG. 1B, the user interface 154 may provide an LLM list 182 with LLM identifiers 184 that identify the LLMs 170 that can be used for the AI insight engine 120. The LLM list 182 may include an LLM identifier 184-1 associated with the LLM 170-1, and an LLM identifier 184-2 associated with the LLM 170-2. Each LLM identifier 184 that is included in the LLM list 182 has a corresponding connector 134 that is used by a prompt manager 130 to communicate with a respective LLM 170. A connector 134-1 is associated with the LLM 170-1, and a connector 134-2 is associated with the LLM 170-2.

In some examples, in response to selection of a UI element 186, an insight request 111 is generated. In response to selection of the LLM identifier 184-1, the prompt manager 130 may use the connector 134-1 to transmit a prompt 140 to the LLM 170-1 and receive a model response 144-1 from the LLM 170-1. The model response 144-1 includes one or more security insight events 146 that are generated by the LLM 170-1 using the security alerts 106. The prompt manager 130 may store the model response 144-1 in a storage 180 for subsequent retrieval. In response to selection of the LLM identifier 184-2, the prompt manager 130 may use the connector 134-2 to transmit a prompt 140 to the LLM 170-2 and receive a model response 144-2 from the LLM 170-2. The model response 144-2 includes one or more security insight events 146 that are generated by the LLM 170-2 using the security alerts 106. The prompt manager 130 may store the model response 144-2 in a storage 180 for subsequent retrieval. In some examples, a user may use multiple LLM 170 to generate different model responses 144. For example, a user may select LLM identifier 184-1 to generate and view the security insight event(s) 146 generated by the LLM 170-1 using the security alerts 106. Then, a user may select LLM identifier 184-2 to generate and view the security insight event(s) generated by the LLM 170-2 using the security alerts 106 (e.g., the same security alerts 106).

The security analytics platform 102 is technically architected to operate with a plurality of different LLMs 170, providing technical advantages in terms of flexibility, cost optimization, and leveraging diverse AI capabilities. This multi-LLM compatibility may be achieved through a technical framework including connectors 134 and an abstraction library 136. For example, a supported LLM 170 has a corresponding connector 134, which is a technical component configured to handle the specific communication protocols, authentication methods, and data formats required to interface with that particular LLM. These connectors abstract away the technical complexities and differences between various LLM APIs. The abstraction library 136 provides a technical layer that allows the AI insight engine 120 and the prompt manager 130 to interact with different LLMs 170 in a standardized and agnostic manner. This library technically generates a prompt 140 in a generic format that can be adapted by the connectors 134 for the specific requirements of each LLM. It also technically processes the structured data 164 received in the model responses 144 from different LLMs to ensure compatibility with the application 174 and the rendering of the insight interface 158.

The technical challenge addressed by this framework lies in the inherent diversity of LLM architectures, APIs, and response formats. Without the connectors 134 and abstraction library 136, integrating and switching between different LLMs would require significant re-engineering of the AI insight engine 120 for each new LLM. The disclosed technical architecture overcomes this challenge by providing a modular and extensible system that can readily incorporate new LLMs by simply developing a new connector, without requiring fundamental changes to the core insight generation logic.

This technical capability to select and switch between different LLMs 170 provides several technical effects such as cost control (e.g., different LLMs have varying computational costs associated with their usage, where the ability to select among them allows organizations to technically optimize their operational expenses by choosing an LLM that provides the necessary level of performance at a lower cost for specific tasks or workloads), speed and performance (e.g., the response time and throughput of different LLMs can vary, where the multi-LLM framework allows users to technically select an LLM that offers better performance characteristics for their current needs, leading to faster insight generation and improved responsiveness of the security analytics platform, and leveraging diverse capabilities (e.g., different LLMs may have varying strengths in analyzing different types of data or identifying specific types of security threats, where the technical ability to switch between LLMs allows users to leverage the specialized capabilities of different models to gain more comprehensive or nuanced insights into security events). The provision of a user interface element to select the desired LLM is a technical feature that directly enables the user to benefit from these technical advantages. The system technically manages the interaction with the selected LLM through the appropriate connector 134 and abstraction library 136 to generate and present security insight events (146) based on the user's choice

Referring back to FIG. 1A, a user may use the interface 154 to initiate an insight request 111. In some examples, user selection of an LLM identifier 184 causes the application 174 to generate and transmit an insight request 111 to the AI insight engine 120. In some examples, user selection of a UI element (e.g., “generate” action item) causes the application 174 to generate and transmit an insight request 111 to the AI insight engine 120. In some examples, the application 174 generates and transmits an insight request 111 based on an interaction with the user interface 154. In some examples, the application 174 generates and transmits an insight request 111 without user prompting or querying (e.g., without the submission of a user query 114 via a chat interface 156). In some examples, the generation of the insight request 111 is not in response to submission of a user query 114 via a chat interface 156. In some examples, the AI insight engine 120 is configured to periodically generate the insight request 111 so that the security analytics platform 102 can automatically detect security insight event(s) 146. For example, the security analytics platform 102 may execute the attack discovery process at periodic or according to a schedule. In some examples, the AI insight engine 120 may render one or more UI interfaces that enable a user to have attack discovery run automatically.

The AI insight engine 120 includes an alert retrieval engine 122. In response to the insight request 111, the alert retrieval engine 122 generates a search query, and searches and retrieves the security alerts 106 from the database 108 that satisfy the search query. In some examples, the search query may define search criteria that is set by the AI insight engine 120. The search query may include a period of time (e.g., last thirty days), specify certain types of security alerts 106, and/or include other search criteria. In some examples, the alert retrieval engine 122 is configured to generate a ranked list of security alerts 106 by ranking the security alerts 106 retrieved from the database 108. In some examples, the alert retrieval engine 122 may retrieve a pre-determined number of security alerts 106 (e.g., twenty, forty, etc.). In some examples, the AI insight engine 120 may generate a UI interface with one or more settings the user to control one or more aspects of the alert retrieval process such as the adjusting the number of security alerts 106 that can be retrieved.

The AI insight engine 120 includes a prompt manager 130 configured to generate a prompt 140 for the LLM 170. In some examples, the prompt manager 130 selects the security alerts 106 retrieved by the alert retrieval engine 122 for inclusion in the prompt 140. In some examples, the prompt manager 130 selects a subset of the security alerts 106 retrieved by the alert retrieval engine 122. In some examples, the prompt manager 130 may select up to a threshold number (e.g., five, ten, fifteen, twenty, thirty, etc.) of security alerts 106 for inclusion in the prompt 140. In some examples, the prompt manager 130 selects the threshold number of top ranked security alerts 106 for inclusion in the prompt 140. In some examples, the selected number of security alerts 106 may be a user control that is selected by the user.

In some examples, the AI insight engine 120 may generate alert summarization data about the security alerts 106 (or a portion thereof) and include the alert summarization data into the prompt 140. In this manner, the number of security alerts 106 that are sent to the LLM 170 may be reduced, which may reduce the computation cost (e.g., CPU, memory usage) of the attack discovery process. In some examples, as one of the initial steps, the AI insight engine 120 may communicate with an LLM 170 (e.g., the same LLM 170 or a different LLM 170 that is specialized to generate summaries) to generate the alert summarization data. For example, the AI insight engine 120 may generate an initial model request, which, when received by the LLM 170 may cause the LLM 170 to generate the alert summarization data. In some examples, the AI insight engine 120 may use one or more technical strategies to handle large volumes of alert data within the constraints of LLM context windows. This may involve techniques such as intelligent sampling, summarization of alert groups, or breaking down the analysis of large alert sets into smaller, manageable chunks for iterative processing.

In some examples, the AI insight engine 120 includes an alert format converter 132 configured to convert a format of the selected security alerts 106 from a first format to a second format. In some examples, the first format includes a JSON format. In some examples, the second format includes a table structure format. In some examples, the second format includes a comma-separated values (CSV) format.

In some examples, the AI insight engine 120 includes a data anonymizer 124 configured to anonymize the security alerts 106 that are included in the prompt 140. The security alerts 106 include data with non-anonymized values 128a such as user identifiers, device identifiers, or other fields that may contain personal or sensitive information. The data anonymizer 124 may convert the data with non-anonymized values 128a to data with anonymized values 128a. The data anonymizer 124 may store a mapping between the anonymized values 128a and the non-anonymized values 128b. In some examples, the data anonymizer 124 anonymizes the security alerts 106 according to one or more settings 126. In some examples, the settings 126 are selectable by the user. For example, a user may select which data (e.g., fields) to be anonymized, and those selections may be stored in the setting 126.

As shown in FIG. IC, the prompt 140 includes formatting instructions 188. The formatting instructions 188 include information on how the model response is formatted. The formatting instructions 188 may define the structure of the insight interface 158 and/or the arrangement of the UI components 160 and which information is associated with each UI component 160. The prompt 140 includes an insights prompt 190. The insights prompt 190 includes instructions on how the security alerts 106 are analyzed, instructions for identifying security insight events 146, instructions for generating the security event information 162, and instructions for identifying related security alerts 106a. The prompt 140 includes the security alerts 106 (e.g., the anonymized alerts selected for inclusion in the prompt 140).

The prompt manager 130 transmits the prompt 140 to the LLM 170 using the connector 134. In response to the prompt 140, the LLM 170 generates a model response 144. The model response 144 includes structured data 164 for an insight interface 158. The structured data 164 is generated by the LLM 170 using the formatting instructions 188, the insights prompt 190, and the security alerts 106 included in the prompt 140. The structured data 164 defines UI components 160 for the insight interface 158. The structured data 164 includes security event information 162 that is used to populate and/or configure the UI components 160. For example, the security event information 162 may be data, generated by the LLM 170, which is used to configure and/or the UI components 160 on the insight interface 158. In some examples, the security event information 162 is the visual data that is displayed in the insight interface 158 in a structured layout.

The model response 144 defines one or more security insight events 146 in a structured layout. For example, the LLM 170 may analyze the security alerts 106 according to the insight prompt 190 and determine that one or a subset of security alerts 106 correspond to a security insight event 146. In some examples, each security insight event 146 corresponds to a separate UI object (e.g., UI card), which can be expanded or minimized (e.g., collapsed) by a user. A security insight event 146 may be a type or category of an active (potential) attack event. In some examples, a security insight event 146 may be referred to as an AI-generated insight. The model response 144 includes information (e.g., a title, a short description) that identifies the security insight event 146. The security insight event 146 includes security event information 162, which is used to populate and/or configure the UI components 160 of a respective security insight event 146.

Referring to FIG. 1D, a model response 144 may identify a security insight event 146-1 and a security insight event 146-2. For example, the LLM 170 may analyze a collection of security alerts 106 and determine that the security alerts 106 (or a subset thereof) correspond to two security insight events, e.g., security insight event 146-1 and security insight event 146-2. An example of the security insight event 146-1 may be malware infection leading to ransomware activity. An example of the security insight event 146-2 may be malware inflection via a malicious office document. These security insight events 146 may relate to separate potential attacks. The security insight event 146-1 includes security event information 162 for the UI components 160 of the security insight event 146-1. The security insight event 146-1 identifies related security alerts 106a-1 that are related to the security insight event 146-1. The security insight event 146-2 includes security event information 162 for the UI components 160 of the security insight event 146-2. The security insight event 146-2 identifies related security alerts 106a-1 that are related to the security insight event 146-2.

The prompt manager 130 may receive the model response 144 from the LLM 170. In some examples, the prompt manager 130 includes a prompt validator 138 configured to determine whether the model response 144 satisfies a formatting structure. If so, the prompt manager 130 may provide the model response 144 to the application 174. The application 174 uses the model response 144 to render the insight interface 158.

In some examples, the AI insight engine 120 may iteratively generate and validate a portion (e.g., each portion) of the security insight events 146. In some examples, generating one or more security insight events 146 from security alerts 106 using an LLM 170 may be referred to as an attack discovery process. In some examples, instead of using a one-shot LLM call (e.g., which returns a single model response 144), the AI insight engine 120 may use a generation graph to iteratively communicate with the LLM 170 to generate and validate separate portions of the security insight events 146. The generation graph may include a plurality of action nodes and links that connect the action nodes. At each action node, the AI insight engine 120 performs an action for the generation of the security insight event(s) 146. At an action node, the AI insight engine 120 may generate an LLM request, which causes the LLM 170 to generate a response. Then, after validation, the process moves to the next action in the generation graph. In some examples, the generation graph is stored at the AI insight engine 120. In some examples, the generation graph is stored at the security service agent 178.

In some examples, at a first action node, the AI insight engine 120 may retrieve the security alerts 106 and communicate with the LLM 170 to detect whether at least a sub-set of the security alerts 106 are related to each other, and, if so, may identify the category of attack. For example, the first action node may cause the AI insight engine 120 to transmit a first model request, and then receive a first model response, where the first model response identifies a group of security alerts 106 related to a first category of attack. Then, the AI insight engine 170 may proceed to validate the first model response (e.g. by checking whether the response includes errors, missing info, etc.). If the validation produces an error message, the AI insight engine 170 may re-generate the model request along with the error message so that the LLM 170 can re-generate the first model response.

In response to successful validation of the first model response, the AI insight engine 120 may proceed to a subsequent action node (e.g., a second action node). At the second action node, the AI insight engine 170 may communicate with the LLM 170 again to determine a next part of the attack discovery process. In some examples, at the second action node, the AI insight engine 170 may generate a second model request which causes the LLM 170 to generate a second model response, where the second model response includes information for the attach chain graphic. Then, the AI insight engine 120 may validate the second model response, and, if the second model response includes one or more errors, the AI insight engine 120 may re-transmit the second model request along with the error messages.

In response to successful validation of the second model response, the AI insight engine 120 may proceed to a third action node. At the third action node, the AI insight engine 120 may generate another part of the security insight event 146. At the third action node, the AI insight engine 120 may communicate with the LLM model 170 to generate information for the summary section 125 and/or the details section 127, computing links for the underlying process or entity (e.g., user entity or device identity), or other aspects of the security insight event 146. This process continues until all the action nodes of the generation graph is completed. Although the generation model is explained with the order of detecting a sub-group of security events 106, generating attack chain graphic information, generating summary information, generating details, and generating the entity or process links, the generation model may reflect any order of generation (e.g., the attack generation graphic is generated after the detail section or the entity links are generated before the generation of the attack graphic, etc.). In some examples, at an iteration (e.g., each iteration), the AI insight engine 120 may insert context data into a respective model request. For example, the AI insight engine 120 may query a vector database 108a for data that satisfies a search query and then insert the retrieved context into the model response.

In further detail, the attack discover process may use a technical graphed approach that facilitates iterative generation and refinement of different parts of the overall structured data result. This addresses the technical challenge of comprehensively analyzing complex attack patterns across numerous security alerts 106 and synthesizing detailed, structured insights in a single pass, which can be technically limited by factors such as LLM context windows and the inherent complexity of correlating diverse data points. The AI insight engine 120 may construct the structured data 164 for security insight events 146 through a series of technical iterations. Each iteration focuses on generating or refining a specific portion of the structured data 164, potentially involving interaction with the LLM (170) and technical validation.

In some examples, the AI insight engine 120 may retrieve relevant security alerts 106 and perform an initial analysis to identify core entities (e.g., affected user identifier 115, device identifier 117, process, file identifier 139, etc.). The AI insight engine 120 programmatically executes a predefined or dynamically generated directed graph of action nodes for each potential security insight event 146 or group of related alerts under analysis. Each action node within this graph represents a specific technical operation or a subset of the overall attack discovery process. The directed edges define the sequence and flow of these operations.

Examples of action nodes within such a graph and their roles in iteratively generating the structured data 164 for a security insight event 146 include alert retrieval node (e.g., retrieves a specific subset of security alerts 106 based on initial criteria or prior nodes' output), initial prompting node (e.g., formulates and transmits an initial prompt 140 to the LLM 170 containing the retrieved alerts and instructions to generate a preliminary part of the structured data, such as the summary section 125), validating node (e.g., technically validates the received model response 144 or a specific portion of the structured data (e.g., checking for structural correctness, consistency with alert data, or adherence to formatting instructions 188)), refinement prompting node (e.g., if validation fails, this node formulates a revised prompt for the LLM 170, including the problematic data portion and technical error information, instructing the LLM to regenerate or correct the specific part), detailed generation node (e.g., formulates a prompt 140 requesting the LLM (170) to generate a more detailed description (e.g., details section 127), potentially focusing on specific entities or timeframes identified by previous nodes), attack chain analysis node (e.g., analyzes correlated alerts and generated details to infer attack progression phases and generates the technical data 196 for the attack chain graphic 131), data integration node (e.g., combines validated portions of structured data generated by different branches or iterations of the graph into the accumulating structured data 164 for the security insight event 146).

In some examples, some of (or each) of the alert retrieval node, initial prompting node, refinement prompting node, detailed generation node, attack chain analysis node, and data integration node include sub-nodes (and corresponding actions).

The execution of this directed graph of action nodes orchestrates the iterative interaction with the LLM (170) and other components (e.g., alert retrieval engine 122, internal validation modules, etc.) to progressively build the complete, validated structured data (164). Each path through a sequence of nodes contributes to generating or refining a specific part of the security insight event's data. This technical process provides a structured and controlled method for performing complex analysis and synthesizing multifaceted results, allowing the AI insight engine 120 to produce accurate and detailed security insight events 146 that are ready for rendering in the user interface 158.

In some examples, the security service agent 178 and/or the AI insight engine 170 may execute the attack discovery process as a background process on the computing device 152. In some examples, to minimize the attack discovery process from impacting the responsiveness of the user interface 154 and to enable the analysis of large volumes of data, the process may be technically implemented to run as a background task. When a user initiates an insight request 111 or the system triggers an automated analysis, the AI insight engine 120 may schedule the attack discovery process to run asynchronously on the server-side (e.g., on server computer(s) 160). This involves queuing the analysis task and executing it independently of the user's active session. Technical mechanisms such as message queues, background workers, and state management are employed to manage the lifecycle of the background process, track its progress, and handle potential errors. The user interface 158 is technically updated asynchronously as results become available or the process reaches different stages. This technical implementation provides a technical advantage of allowing users to continue interacting with the security analytics platform 102 without interruption while potentially time-consuming analysis is performed, thereby improving the overall user experience and system usability.

In some examples, the AI insight engine 120 or the security service agent 178 may store the results of the attack discovery process (e.g., the security insight event(s) 146) in browser storage. In some examples, the AI insight engine 120 or the security service agent 178 may store results of the attack discovery process (e.g., the security insight event(s) 146) in the vector database 108a, which may represent a persisted storage device. For example, to increase durability, scalability, and central accessibility of the generated security insight events 146, the results, including the structured data 164 from the model response(s) 144, are technically stored using persistent mechanisms, specifically within a database 108 (e.g., a vector database 108a). In some examples, unlike ephemeral browser storage, which is limited in capacity, tied to a specific client device, and susceptible to data loss, storing results in the vector database 108a provides a robust and scalable solution. The structured data 164 may be indexed in a manner that facilitates rapid searching, filtering, and aggregation of security insight events 146 across potentially large datasets. This technical change may enable multiple users to access and collaborate on the discovered insights, allows for historical analysis and trending of attack patterns, and ensures that valuable security intelligence is preserved. The integration with the vector database 108a may involve technical data mapping and indexing strategies optimized for the structure and query patterns of security insight events 146.

In some examples, the prompt(s) 140 include one or more dynamic prompts. For example, the AI insight engine 120 uses one or dynamic prompts that reference and incorporate content from saved objects stored persistently within the system (e.g., in the database 108, the vector database 108a). The prompt manager 130 may be configured to retrieve components of the prompt (e.g., formatting instructions 188, insights prompt 190, or custom knowledge data 175) from these saved objects. A technical interface (e.g., setting interface 198, or a dedicated prompt management interface) allows authorized users to view, modify, or overwrite the content of these saved prompt objects on demand. This technical approach provides significant flexibility, enabling administrators or expert users to technically tune the behavior and instructions provided to the LLM (170) without requiring software code deployments. The technical effects include the ability to rapidly adapt the attack discovery process to new threat intelligence, refine the analysis methodology, or customize the output format, thereby ensuring the system remains effective and aligned with evolving security requirements and organizational policies.

FIG. 1E illustrates a portion of the insight interface 158. The application 174 uses the model response 144 to render the insight interface 158 of FIG. 1. The UI components of the insight interface 158 are configured based on the structured data 164 of the model response 144. The insight interface 158 displays a security insight event 146 generated by the LLM 170. In some examples, the security insight event 146 is a UI object (e.g., a UI card) that may be expanded or collapsed (e.g., minimized) by a user). The security insight event 146 includes a title 143 (e.g., malware infection leading to ransomware activity). The security insight event 146 includes an attack chain graphic 131-1 (e.g., a smaller attack chain graphic) that depicts a plurality of attack progression phases. The attack chain graphic 131-1 may visually highlight one or more of the progression phases. In the example of FIG. 1E, the security insight event 146 has achieved three progression phases (e.g., the execution phase, the persistence phase, and the privilege escalation phase), and, therefore, the attack chain graphic 131-1 visually highlights those progression phases. The security insight event 146 includes an alert graphic 145 that indicates the number of related security alerts 106a associated with the security insight event 146. The security insight event 146 includes a selectable action element 147, which, when selected, causes the display of a UI menu with one or more actions to be taken by the user.

The security insight event 146 includes an entity summary object 113 that identifies one or more entities associated with the security insight event 146. For example, the entity summary object 113 identifies a device identifier 117 and a user identifier 115 associated with the security insight event 146. The security insight event 146 includes a summary section 125 that includes a summary of the security insight event 146. The security insight event 146 includes a details section 127 that includes a detailed description of the security insight event 146. The security insight event 146 includes an attack chain graphic 131-2 that visually highlights one or more of the progression phases. In the example of FIG. 1E, the security insight event 146 has achieved three progression phases (e.g., the execution phase, the persistence phase, and the privilege escalation phase), and, therefore, the attack chain graphic 131-2 visually highlights those progression phases. The attack chain graphic 131-2 may be a larger visual graphic than the attack chain graphic 131-1 and include more information about the attack chain progression.

The security insight event 146 may include selectable elements 133 associated with entities that are mentioned in the security insight event 146. A selectable element 133, when selected, is configured to render an entity interface (e.g., an entity page) that provides information about a respective entity. For example, the entity summary object 113 mentions a device identifier 117 and a user identifier 115 that is associated with the attack. The device identifier 117 and the user identifier 115 are selectable elements 133. In response to a selection to the device identifier 117, the application 174 may render a device interface that displays information about the device associated with the device identifier 117. In response to a selection to the user identifier 115, the application 174 may render an interface that displays information about the user associated with the device identifier 117. The selectable elements 133 may correspond to other entities such as process identifiers 137 and/or file identifiers 139. In response to a selection to the process identifier 137, the application 174 may render a process interface that displays information about the process associated with the process identifier 137. In response to a selection to the file identifier 139, the application 174 may render a file interface that displays information about the file associated with the file identifier 139.

A user may be able to take other actions with respect to the security insight event 146. For example, the security insight event 146 may include a selectable chat interface element 149, which, when selected, causes the display of a chat interface 156 to enable the user to chat with the LLM 170. The security insight event 146 includes a selectable timeline clement 161a, which, when selected, causes the display of an interface (e.g., interface 158b) associated with a timeline management system 118-2. The security insight event 146 includes an alerts tab 141, which, when selected, causes the insight interface 158 to display a list of the related security alerts 106a.

In some examples, referring to FIG. IF, the LLM 170 may determine whether the security insight event 146 satisfies a progression phase of an attack chain graphic 131 based on the security alerts 106 included in the prompt 140. For example, a security alert 106-1 may indicate that a first progression phase (e.g., execution phase) is achieved, and a security alert 106-2 may indicate that a second progression phase (e.g., persistence phase) is achieved. The LLM 170 may identify those progression phases by obtaining information from the security alert 106-1 and the security alert 106-2. In some examples, for one or more of the progression phases of the attack chain graphic 131, the security alerts 106 may not indicate whether a particular progression phase has been achieved. In some examples, the LLM 170 may analyze the security alerts 106 and make a prediction on whether other progression phases have been met. For a security insight event 146, the model response 144 may include attack chain phase data 196 about the progression phases of the attack chain graphic 131. The attack chain phase data 196 is used to configure the attack chain graphic 131 on the insight interface 158.

Referring to FIGS. 1A and 1G, the application 174 uses the model response 144 to render the insight interface 158. The insight interface 158 displays one or more security insight events 146, as shown in FIG. 1E. The insight interface 158 includes an action 172, which, when selected, may initiate a security management system 118 of the security analytics platform 102. In other words, the AI insight engine 120 may be integrated with other security management systems 118 to initiate other workflows (from the insight interface 158) that relate to the security insight event 146 and/or the security alerts 106.

In some examples, the security management system 118 includes a case management system 118-1 that enables the user to create, modify, and/or manage cases associated with the security alerts 106. In some examples, the case management system 118-1 provides one or more interface(s) 158a that are separate from the insight interface 158. In some examples, the action 172 is selected from a menu associated with selectable action element 149 on FIG. 1E. In some examples, selection of the action 172 causes the display of an interface 158a associated with the case management system 118-1. The AI insight engine 120 may insert at least some of the information of the security insight event 146 into the appropriate UI components 160a of the interface 158a associated with the case management system 118-1.

In some examples, the security management system 118 includes a timeline management system 118-2 that enables the user to create a timeline of related security alerts 106a. In some examples, the timeline management system 118-2 provides one or more interface(s) 158b that are separate from the insight interface 158. In some examples, the action 172 is selected from the selectable timeline element 161a in FIG. 1E. a menu associated with selectable action element 149 on FIG. 1E. In some examples, selection of the action 172 causes the display of an interface 158b associated with the timeline management system 118-2. The AI insight engine 120 may insert at least some of the information of the security insight event 146 into the appropriate UI components 160b of the interface 158b associated with the timeline management system 118-2. In some examples, the AI insight engine 120 may populate the related security alerts 106a from the security insight event 146 into the timeline management system 118-2.

Referring to FIGS. 1A and 1H, the insight interface 158 includes a UI element 163 that enables the user to select between displaying anonymized values 128a and non-anonymized values 128b in the security insight event 146. In some examples, the UI element 163 is a toggle switch that enables switching between the anonymized values 128a and the non-anonymized values 128b. When anonymized values are deactivated, the data anonymizer 124 may replace the anonymized values 128a with the non-anonymized values 128b in the insight interface 158 based on the mapping stored at the data anonymizer 124. Then, when anonymized values are activated, the data anonymizer 124 may replace the non-anonymized values 128b with the anonymized values 128a in the insight interface 158 based on the mapping stored at the data anonymizer 124. In some examples, the application 174 may display a setting interface 198 that enables a user to adjust one or more settings 126 for anonymizing data. FIG. 1I illustrates a setting interface 165 according to an aspect. The setting interface 165 includes a plurality of rows, where each row corresponds to a separate field 167 with a selectable control 171 to enable or disable anonymization with respect to that field 167 and a status field 169 that indicates the status of the anonymization.

Referring to FIG. 1J, in some examples, the database 108 includes custom knowledge data 175. The custom knowledge data 175 may include information that can be provided as context for a prompt (e.g., prompt 112, prompt 140). In some examples, the custom knowledge data 175 may include information about internal documentation, runbooks (e.g., playbooks for IT procedures), software development data, communications from an internal messaging platform, a search query language, and/or alert data. In some examples, users can add new entries to the custom knowledge data 175 via an interface. In some examples, the custom knowledge data 175 is associated with an organization 181. In some examples, the custom knowledge data 175 includes policies 177 and/or guidelines 179 associated with the organization 181.

In some examples, the prompt manager 130 may generate the prompt 140 to also include the custom knowledge data 175. For example, the prompt manager 130 may retrieve a portion of the custom knowledge data 175 from the database 108 and include that information with the prompt 140. In some examples, the prompt manager 130 generates a search query based on the retrieved security alerts 106 and retrieves a portion of the custom knowledge data 175 that satisfies the search query. In some examples, the custom knowledge data 175 is used for the AI assistant engine 110. For example, in response to a user query 114, a portion of the custom knowledge data 175 is retrieved and included in a prompt 112 that is transmitted to the LLM 170. The prompt 112 includes the user query 114. In some examples, the prompt 112 includes the security insight event(s) 146.

In some examples, the database 108 includes a vector database 108a. A vector database 108a is a database that stores data (e.g., data points) as vectors, where the vectors represent features or attributes of the data. A vector may be a series of numerical values or a multi-dimensional array that represent characteristics or features of a piece of data. Unlike traditional databases that store data in tables with rows and columns, a vector database 108a stores data points as vectors (e.g., high-dimensional vectors). Each dimension may represent a specific feature or attribute of the data. For example, a text document might be represented as a vector where each element reflects the weight or importance of a specific word within the document. In some examples, the vector database 108a may function as a memory device (e.g., a long-term memory) and/or a semantic knowledge store for an LLM 170. In some examples, the security alerts 106 are vectorized and stored in the vector database 108a, where the alert retrieval engine 122 obtains the security alerts 106 from the vector database 108a. In some examples, the vector database 108a stores other information associated with an organization as vectors in the vector database 108a. In some examples, when generating a prompt 140, the prompt manager 130 may retrieve data (e.g., private data) associated with the organization, and insert the private data as context data for the LLM 170.

FIG. 1K illustrates the security system 100 according to an aspect. In some examples, the security system 100 includes an ingestion engine 185 configured to receive, index, and store documents 109 in the database 108. The database 108 may also store the security alerts 106 associated with an organization 181. The documents 109 may include private documents, e.g., documents that are only accessible by authorized users of the database 108. The documents 109 may include public documents, e.g., documents that are accessible by the general public. The documents 109 may include private and public documents.

During data ingestion, the ingestion engine 185 may persist data to storage (e.g., the database 108), where the data may include documents 109 and/or index structures. The database 108 may be stored on the server computer 160. As shown in FIG. 1J, the database 108 may also include the custom knowledge data 175. In some examples, the database 108 is a vector database 108a. The ingestion engine 185 may receive documents 109 to be stored, managed, and searched by a search engine 183. The ingestion engine 185 may receive (e.g., ingest) data (e.g., documents 109) from one or more computing devices 152. The ingestion engine 185 may generate one or more index structures about the documents 109. An index structure may be a data structure that includes information about the documents 109 that have been indexed. In some examples, an index structure is referred to as an index, a Lucene index (e.g., Lucene files) or segments (e.g., Lucene segments) or a stateless compound commit file.

The search engine 183 may search the index structure(s) for responsive documents 109 and/or security alerts 106 that are responsive to the search query. In some examples, the alert retrieval engine 122 uses the search engine 183 to retrieve relevant security alerts 106 from the database 108. The search engine 183 receives a search query and retrieves responsive documents 109 and/or security alerts 106 that are responsive to the search query from the database 108. For example, the search engine 183 may receive the search term(s) specified by the search query and obtain the relevant search results (e.g., documents 109 and/or security alerts 106) by searching the index structure(s). In some examples, the search engine 183 may rank the search results.

In some examples, the search engine 183 may retrieve, in response to a search query, a set of semantically similar results (e.g., security alerts 106 and/or documents 109) according to one or more search strategies. Using the search strategies discussed herein, search results may include a set of semantically similar results that are relevant (e.g., highly relevant) to the search query. In some examples, the search results include documents 109 (which may include custom knowledge data 175), where a lesser number of documents 109 may be included in a prompt 112 (e.g., from the AI assistant engine 110) (thereby reducing the computational cost of processing a LLM query). In some examples, the search results include security alerts 106, where a lesser number of security alerts 106 can be included in the prompt 140, thereby reducing the token size of the prompt 140 (thereby reducing the computational cost of processing a LLM query). The search strategies may include a vector database search, a natural language processing (NLP) enrichment search, a late interaction model search, and/or a regular token matching search. In some examples, the search engine 183 uses a hybrid search that uses a combination of two or more of the following search strategies: a vector database search, an NLP enrichment search, a late interaction model search, and/or a regular token matching search.

In some examples, when inserting context into a prompt 140, the prompt manager 130 may generate a query and initiate retrieval of data, that is responsive to the query, from the vector database 108a. For example, the prompt manager 130 may execute a vector search to find semantically similar data portions (e.g., sentences, paragraphs, or documents) in the vector database 108a. In some examples, the prompt manager 130 may generate a query vector using the textual data of the query and identify data points with vector representations closest to the query vector.

The computing device 152 may be any type of computing device that includes one or more processors 101, one or more memory devices 103, a display 187, and an operating system 105 configured to execute (or assist with executing) an application 174. In some examples, the application 174 includes a browser application 176. The browser application 176 includes the security service agent 178. In some examples, the security service agent 178 includes the AI insight engine 120 (or a portion thereof). For example, the security service agent 178 may execute one or more functionalities associated with the AI insight engine 120. In some examples, the AI insight engine 120 (or a portion thereof) is executable by the server computer 160.

The application 174 may be a program configured to communicate with the security analytics platform 102, including the security alert manager 104, the AI assistant engine 110, the security management system(s) 118, and/or the AI insight engine 120. In some examples, the application 174 is a native application installable on the operating system 105. In some examples, the application 174 is a web application executable by a browser application 176. In some examples, the application 174 is a web page executable by a browser application 176. In some examples, the user interface(s) 154 is/are interfaces of the security analytics platform 102, which may include the insight interface 158 of the AI insight engine 120 and/or other interfaces associated with other security management systems 118 of the security analytics platform 102. In some examples, the computing device 152 is a laptop computer. In some examples, the computing device 152 is a desktop computer. In some examples, the computing device 152 is a tablet computer. In some examples, the computing device 152 is a smartphone. In some examples, the computing device 152 is a wearable device (e.g., a head-mounted display device such as an augmented reality (AR) or a virtual reality (VR) device).

A browser application 176 is a web browser configured to access information on the Internet. The browser application 176 may launch one or more browser tabs in the context of one or more browser windows on a display 187 of the computing device 152. A browser tab may display content (e.g., web content) associated with a web document (e.g., webpage, PDF, images, videos, etc.) and/or an application such as a web application, progressive web application (PWA), and/or extension. A web application may be an application program that is stored on a remote server (e.g., server computer 160) and delivered over the network through the browser application (e.g., a browser tab).

The operating system 105 is a system software that manages computer hardware, software resources and provides common services for the applications 174. In some examples, the operating system 105 is an operating system designed for a larger display 187 such as a laptop or desktop (e.g., sometimes referred to as a desktop operating system). In some examples, the operating system 105 is an operating system for a smaller display 187 such as a tablet or a smartphone (e.g., sometimes referred to as a mobile operating system).

The processor(s) 101 may be formed in a substrate configured to execute one or more machine executable instructions or pieces of software, firmware, or a combination thereof. The processor(s) 101 can be semiconductor-based-that is, the processors can include semiconductor material that can perform digital logic. The memory device(s) 103 may include a main memory that stores information in a format that can be read and/or executed by the processor(s) 101. The memory device(s) 103 may store the operating system 105, including the application 174 (e.g., the security service agent 178) that, when executed by the processors 101, performs certain operations discussed with reference to the application 174 discussed herein. In some examples, the memory device(s) 103 store one or more portions of the security analytics platform 102 that, when executed by the processors 101, performs certain operations discussed with reference to the security analytics platform 102. In some examples, the memory device(s) 103 includes a non-transitory computer-readable medium that includes executable instructions that cause at least one processor (e.g., the processors 101) to execute the operations discussed herein.

The server computer 160 may be computing devices that take the form of a number of different devices, for example a standard server, a group of such servers, or a rack server system. The server computer 160 may represent a single server computer or multiple server computer. In some examples, the server computer 160 may represent multiple server computers that are in communication with each other. In some examples, the server computer 160 may be a single system sharing components such as processors and memories. In some examples, the server computer 160 may be multiple systems that do not share processors and memories. The network may include the Internet and/or other types of data networks, such as a local area network (LAN), a wide area network (WAN), a cellular network, satellite network, or other types of data networks. The network may also include any number of computing devices (e.g., computers, servers, routers, network switches, etc.) that are configured to receive and/or transmit data within the network. The network may further include any number of hardwired and/or wireless connections.

The server computer(s) 160 may include one or more processors 151 formed in a substrate, an operating system (not shown) and one or more memory devices 153. The memory device(s) 153 may represent any kind of (or multiple kinds of) memory (e.g., RAM, flash, cache, disk, tape, etc.). In some examples (not shown), the memory devices may include external storage, e.g., memory physically remote from but accessible by the server computer(s) 160. The processor(s) 151 may be formed in a substrate configured to execute one or more machine executable instructions or pieces of software, firmware, or a combination thereof. The processor(s) 151 can be semiconductor-based-that is, the processors can include semiconductor material that can perform digital logic. The memory device(s) 153 may store information in a format that can be read and/or executed by the processor(s) 151. The memory device(s) 153 may store one or more portions of the security analytics platform 102, that, when executed by the processor(s) 151, perform certain operations discussed herein. In some examples, the memory device(s) 153 includes a non-transitory computer-readable medium that includes executable instructions that cause at least one processor (e.g., the processor(s) 151) to execute operations.

The LLM 170 may include any type of pre-trained LLM configured to generate a model response 144 in response to a prompt 140 or a prompt 112. In some examples, the LLM 170 is stored on a server computer 160a that is separate from the server computer 160 that hosts the security analytics platform 102. The server computer 160a may be server computing resources that are owned and/or managed by an entity that is separate from an entity that owns and/or manages the server computer 160. In some examples, the LLM 170 is a third-party LLM that is not managed or owned by the security system 100. In some examples, the LLM 170 is a predefined LLM that is managed or owned by the security system 100. In some examples, the LLM 170 is stored on the server computer 160 that hosts the security analytics platform 102.

The LLM 170 includes weights. The weights are numerical parameters that the LLM 170 learns during the training process. The weights are used to compute the output (e.g., the model response 144) of the LLM 170. The LLM 170 may receive the prompt 140 or the prompt 112 from the prompt manager 130. The LLM 170 includes a pre-processing engine configured to pre-process the information in the prompt 140 or the prompt 112. Pre-processing may include converting the textual input of the prompt 140 or the prompt 112 to individual tokens (e.g., words, phrases, or characters). Pre-processing may include other operations such as removing stop words (e.g., “the”, “and”, “of”) or other terms or syntax that do not impart any meaning to the LLM 170. The LLM 170 includes an embedding engine configured to generate word embeddings from the pre-processed text input. The word embeddings may be vector representations that assist the LLM 170 to capture the semantic meaning of the input tokens and may assist the LLM 170 to better understand the relationships between the input tokens.

The LLM 170 includes neural network(s) configured to receive the word embeddings and generate an output. A neural network includes multiple layers of interconnected neurons (e.g., nodes). The neural network may include an input layer, one or more hidden layers, and an output later. The output may include a sequence of output word probability distributions, where each output distribution represents the probability of the next word in the sequence given the input sequence so far. In some examples, the output may be represented as a probability distribution over the vocabulary or a subset of the vocabulary. The neural network(s) is configured to receive the word embeddings and generate an output, and, in some examples, the query activity (e.g., previous natural language queries and textual responses). The output may represent a version of the model response 144. The output may include a sequence of output word probability distributions, where each output distribution represents the probability of the next word in the sequence given the input sequence so far. In some examples, the output may be represented as a probability distribution over the vocabulary or a subset of the vocabulary. The decoder is configured to receive the output and generate the model response 144. In some examples, the decoder may select the most likely instruction, sampling from a probability distribution, or using other techniques to generate coherent and well written model response 144.

In some examples, the database 108 may be stored on a server computer 160 that also includes, or is associated with an entity that also manages, the security analytics platform 102. In some examples, the database 108 is external to the server computer 160 that hosts the security analytics platform 102. In other words, in some examples, the database 108 is owned and/or managed by an entity that is different from the entity that owns and/or manages the security analytics platform 102. In some examples, the database 108 may be an external data store.

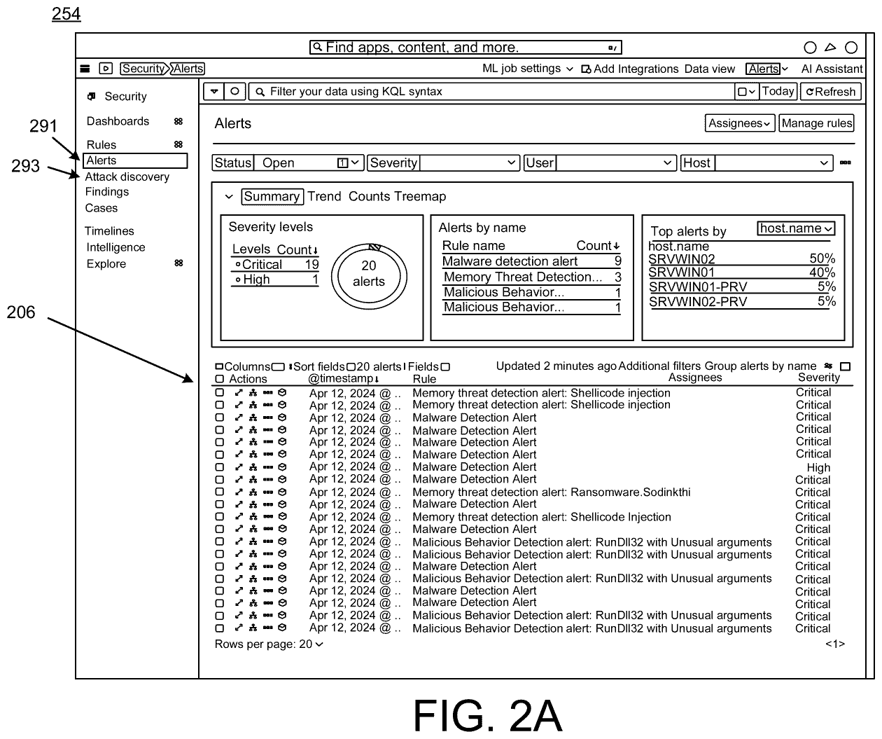

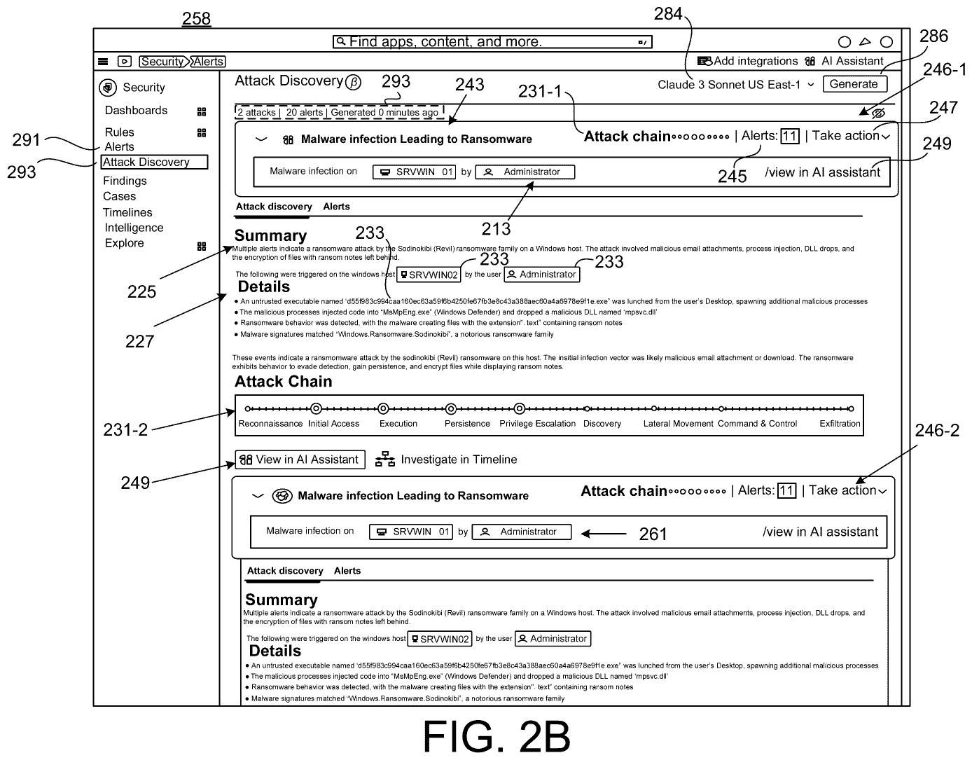

FIG. 2A illustrates an example of a user interface 254 associated with a security analytics platform (e.g., the security analytics platform 102 of FIGS. 1A to 1K). The user interface 254 of FIG. 2A depicts an alerts tab 291 with a plurality of security alerts 206. The user interface 254 includes an AI insights tab 293. In response to selection of the AI insights tab 293, an application (e.g., the application 174 of FIGS. 1A to 1K) may render an insight interface 258 as shown in FIG. 2B. The insight interface 258 may be an example of the insight interface 158 of FIGS. 1A to 1K and may include any of the details discussed with reference to those figures. The insight interface 258 includes an alerts tab 291 and an AI insights tab 293. As shown in FIG. 2B, the insight interface 258 identifies a security insight event 246-1 and a security insight event 246-2. As explained with reference to FIGS. 1A to 1K, the insight interface 258 is configured (e.g., powered by) the structured data 164 (e.g., the JSON data) of the model response 144. In other words, the UI components of the insight interface 258 are configured based on the structured data 164 of the model response 144.

In some examples, the insight interface 258 includes summary information 293 about the security insight events generated by the LLM. The summary information 293 may indicate the number of security insight events, the number of security alerts associated with the security insight events, and the time in which the security insight events were generated. The insight interface 258 includes an LLM identifier 284 that identifies a particular LLM that generates the security insight events. The insight interface 258 includes a generate element 286, which, when selected, causes the generation of the security insight events using the specified LLM. In some examples, selection of the generate element 286 causes the insight request 111 of FIG. 1A to be generated.

In some examples, the security insight event 246-1 and the security insight event 246-2 are separate UI objects (e.g., UI cards) that may be expanded or collapsed (e.g., minimized) by a user). The security insight event 246-1 includes a title 243 (e.g., malware infection leading to ransomware activity). The security insight event 246-1 includes an attack chain graphic 231-1 (e.g., a smaller attack chain graphic) that depicts a plurality of attack progression phases. The attack chain graphic 231-1 may visually highlight one or more of the progression phases. As shown in FIG. 2B, the security insight event 246-1 has achieved three progression phases (e.g., the execution phase, the persistence phase, and the privilege escalation phase), and, therefore, the attack chain graphic 231-1 visually highlights those progression phases. The security insight event 246-1 includes an alert graphic 245 that indicates the number of related security alerts associated with the security insight event 246-1. The security insight event 246-1 includes a selectable action element 247, which, when selected, causes the display of a UI menu with one or more actions (e.g., actions 172 of FIGS. 1A to 1K) to be taken by the user.

The security insight event 246-1 includes an entity summary object 213 that identifies one or more entities associated with the security insight event 246-1. For example, the entity summary object 213 identifies a device identifier and a user identifier associated with the security insight event 246-1. The security insight event 246-1 includes a summary section 225 that includes a summary of the security insight event 246-1. The security insight event 246-1 includes a details section 227 that includes a detailed description of the security insight event 246-1. The security insight event 246-1 includes an attack chain graphic 231-2 that visually highlights one or more of the progression phases. As shown in FIG. 2B, the security insight event 246-1 has achieved three progression phases (e.g., the execution phase, the persistence phase, and the privilege escalation phase), and, therefore, the attack chain graphic 231-2 visually highlights those progression phases. The attack chain graphic 231-2 may be a larger visual graphic than the attack chain graphic 231-1 and include more information about the attack chain progression.

The security insight event 246-1 may include selectable elements 233 associated with entities that are mentioned in the security insight event 246-1. A selectable element 233, when selected, is configured to render an entity interface (e.g., an entity page) that provides information about a respective entity. For example, the entity summary object 213 mentions a device identifier and a user identifier that is associated with the attack. The device identifier and the user identifier are selectable elements 233. In response to a selection to the device identifier, the application may render a device interface that displays information about the device associated with the device identifier. In response to a selection to the user identifier, the application may render an interface that displays information about the user associated with the device identifier. The selectable elements 233 may correspond to other entities such as process identifiers and/or file identifiers. In response to a selection to the process identifier, the application may render a process interface that displays information about the process associated with the process identifier. In response to a selection to the file identifier, the application may render a file interface that displays information about the file associated with the file identifier.

A user may be able to take other actions with respect to the security insight event 246-1. For example, the security insight event 246-1 may include a selectable chat interface element 249, which, when selected, causes the display of a chat interface (e.g., the chat interface 156 of FIG. 1A) to enable the user to chat with the LLM 170 about the security insight event 246-1. In some examples, the AI insights engine may cause information from the security insight event 246-1 to be included in a prompt (e.g., the prompt 112) that also includes the user query. The security insight event 246-1 includes a selectable timeline element 261, which, when selected, causes the display of an interface (e.g., interface 158b) associated with a timeline management system (e.g., the timeline management system 118-2 of FIGS. 1A to 1K). The security insight event 246-2 may have the same structure and UI components as the security insight event 246-1, but with information that corresponds to the security insight event 246-2.

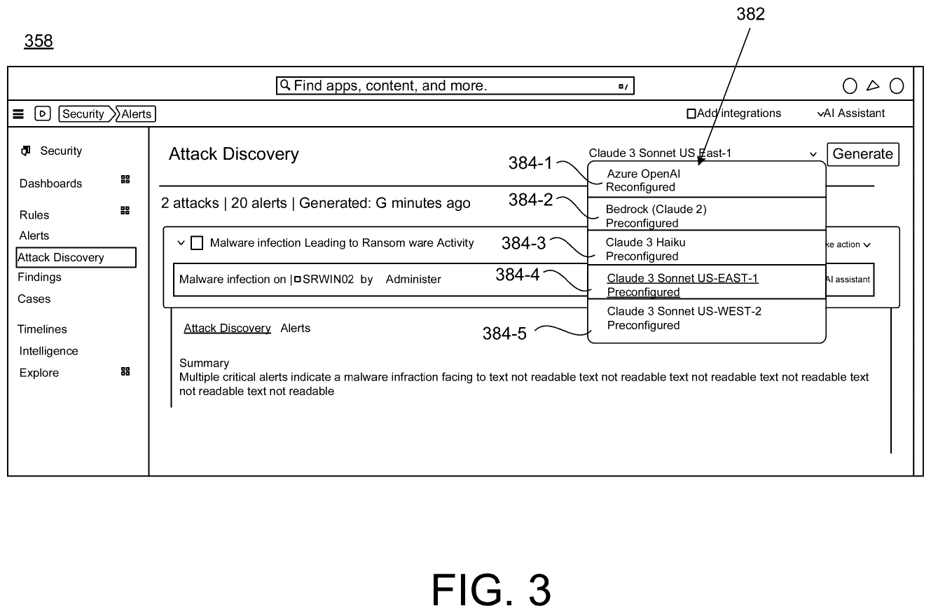

FIG. 3 illustrates an example of an insight interface 358 according to another aspect. The insight interface 358 includes an LLM list 382 with a plurality of LLM identifiers. The LLM identifiers include an LLM identifier 384-1 associated with a first LLM, an LLM identifier 384-2 associated with a second LLM, an LLM identifier 384-3 associated with a third LLM, an LLM identifier 384-4 associated with a fourth LLM, an LLM identifier 384-5 associated with a fifth LLM. A user may select one of the LLM from the LLM list 382 to generate security insight events.

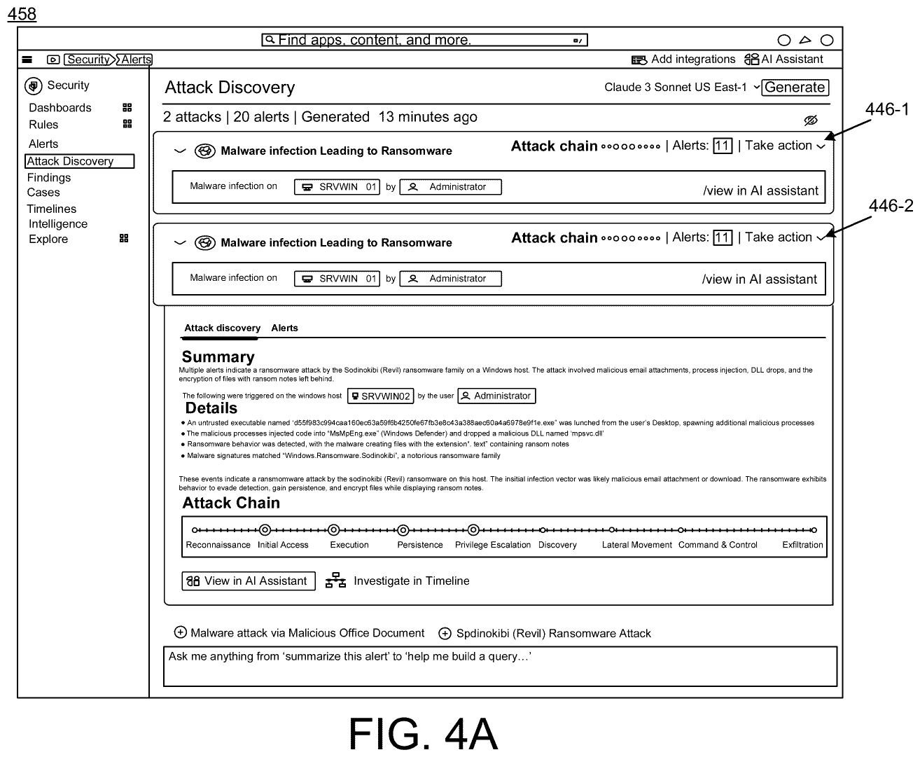

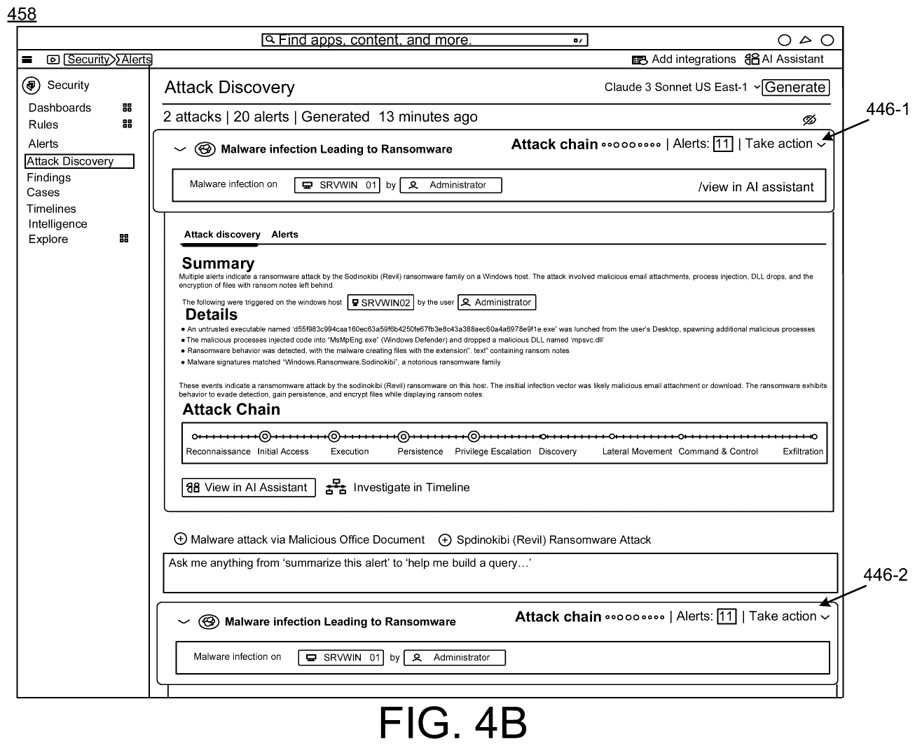

FIGS. 4A and 4B illustrate an example insight interface 458 according to another aspect. In FIG. 4A, the insight interface 458 depicts a security insight event 446-1 in a collapsed state, and a security insight event 446-2 in an expanded state. In response to selection of the security insight event 446-1, the application may display the security insight event 446-2 in an expanded state.

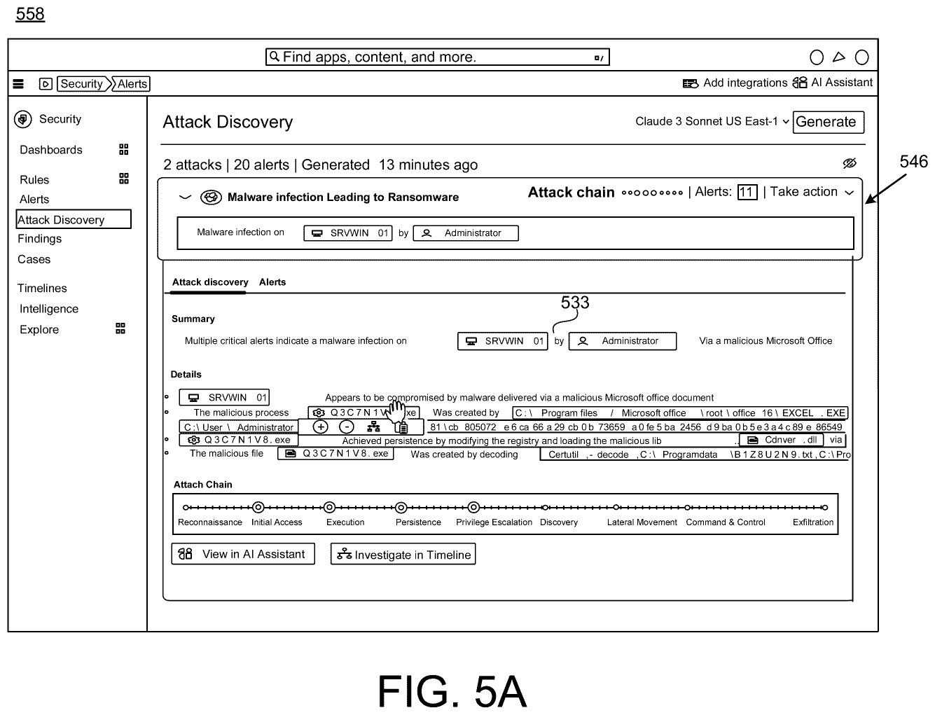

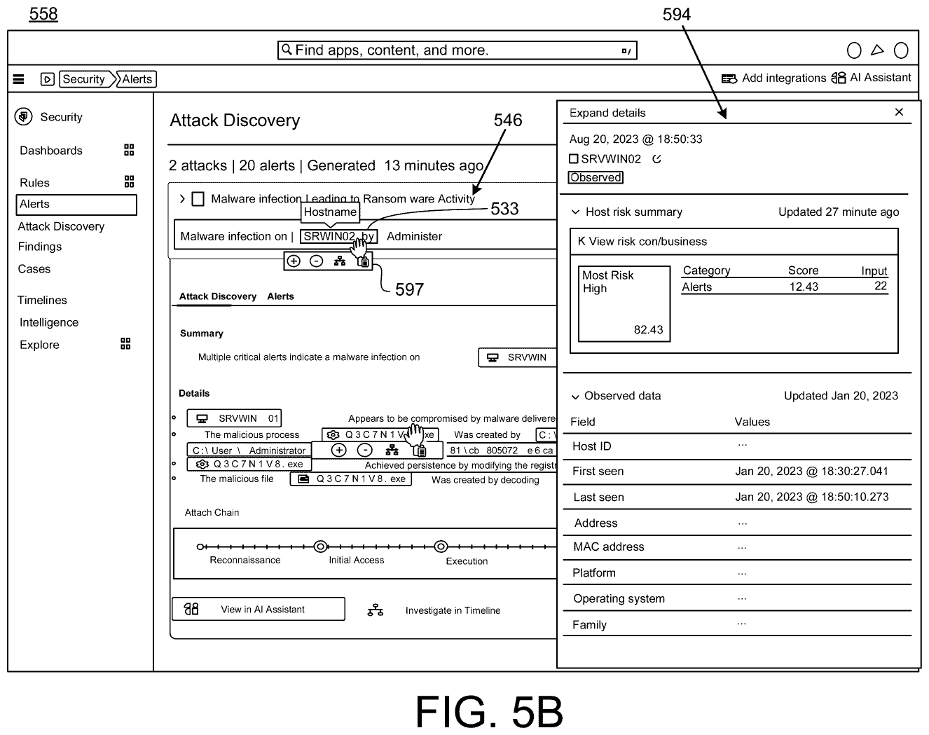

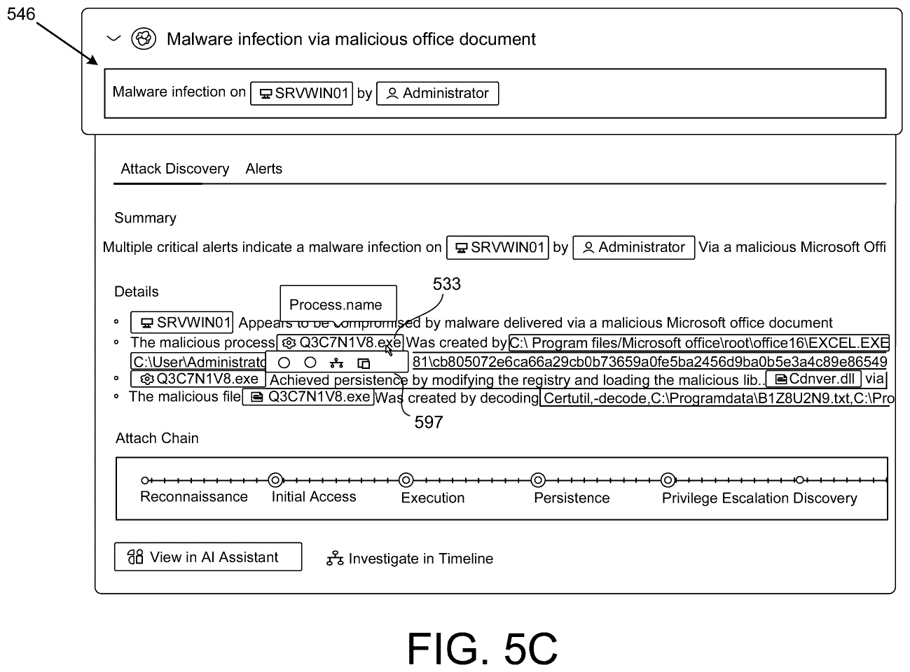

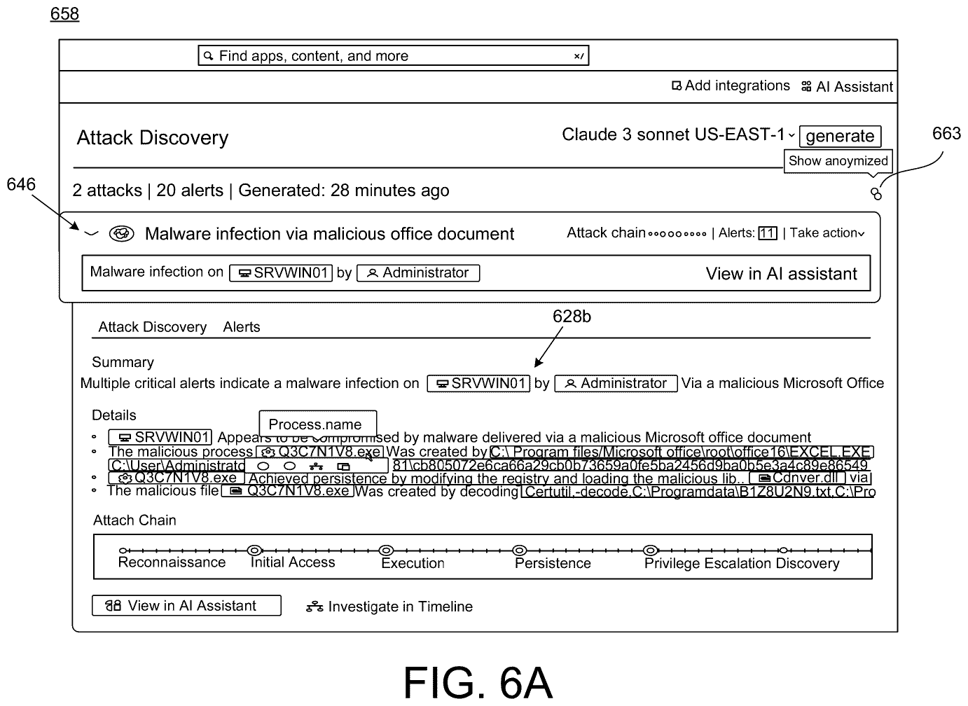

FIGS. 5A to 5C illustrate an insight interface 558 according to another aspect. The insight interface 558 displays a security insight event 546. In FIG. 5A, the security insight event 546 includes a selectable element 533 corresponding to an entity (e.g., a device identifier). In response to selection of the selectable element 533, the application may render an entity page 594 with information about the entity. In some examples, the interface 558 includes a hover element 597 associated with the entity that displays one or more action items to be token with respect to the entity. As shown in FIG. 5C, the insight interface 558 displays a hover element 597 associated with an entity (e.g., a process entity), where the hover clement 597 provides one or more action items to be taken with respect to the entity.

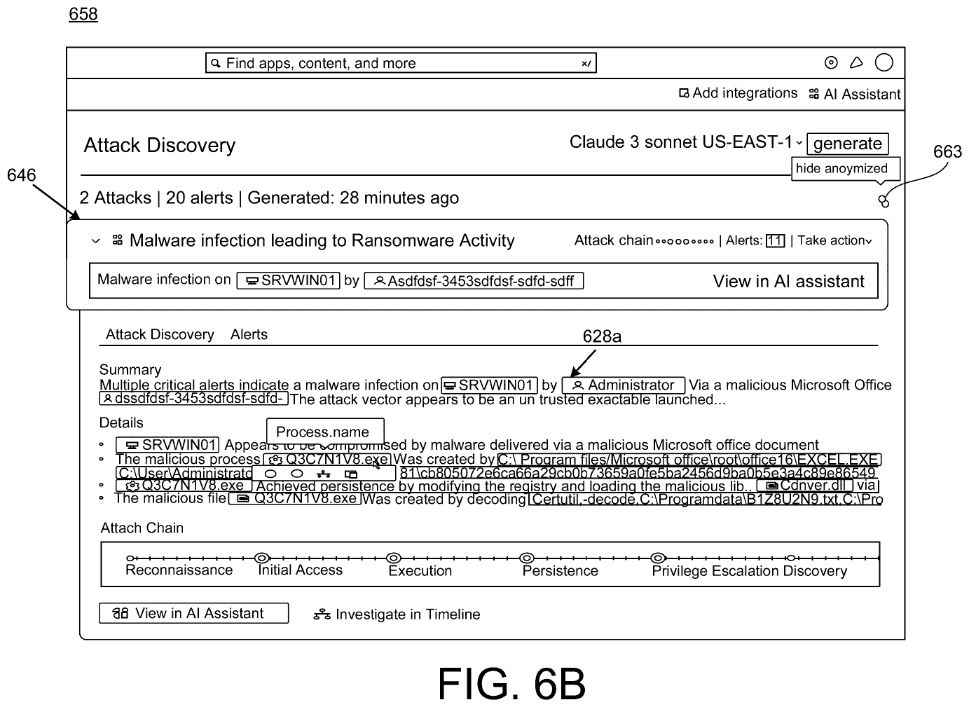

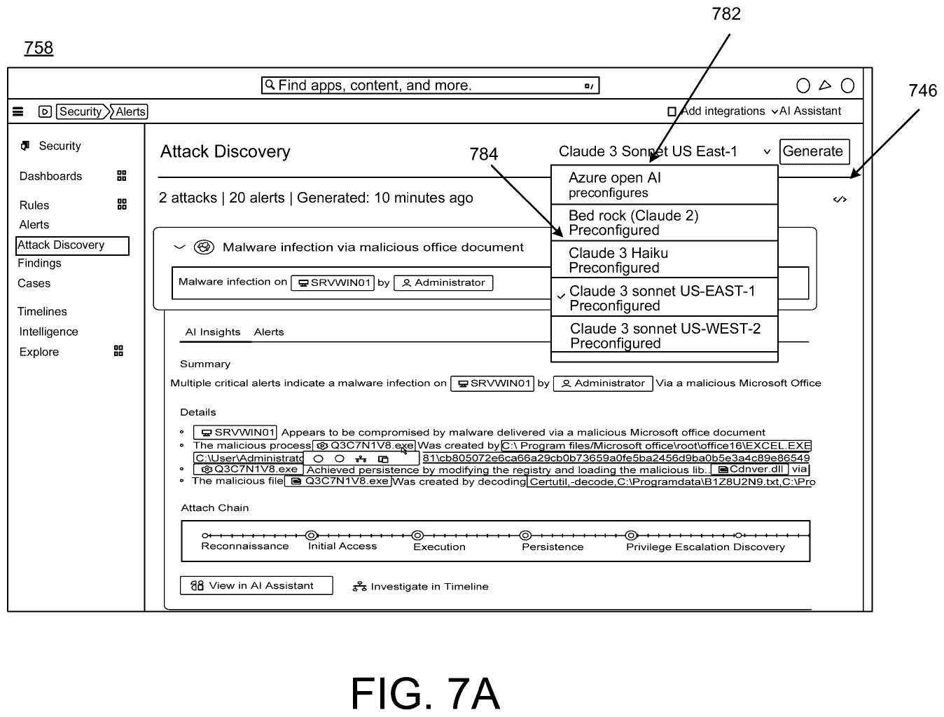

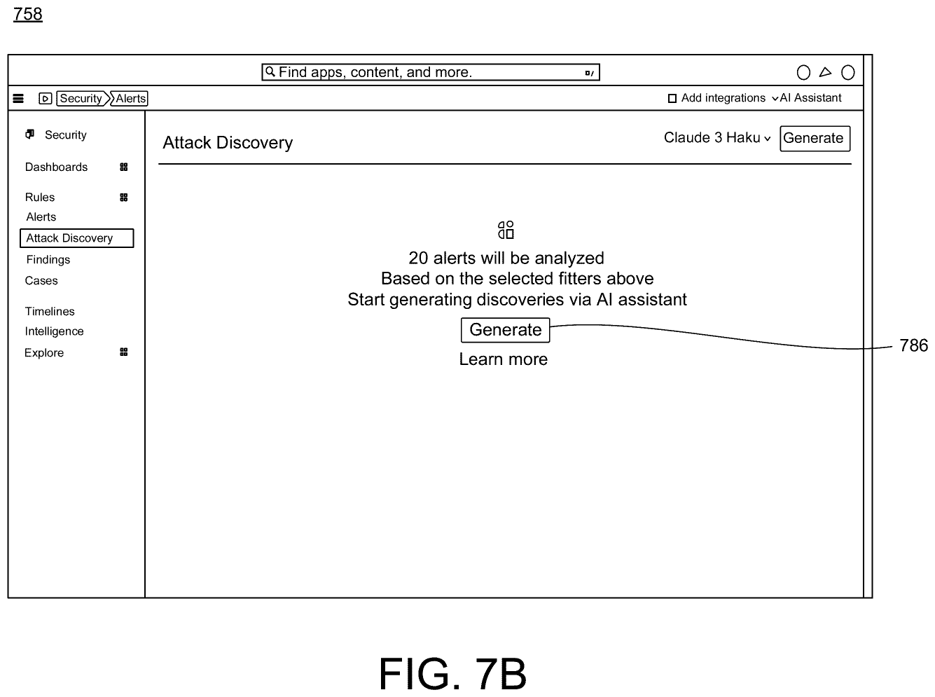

FIGS. 6A and 6B illustrate an insight interface 658 according to another aspect. The insight interface 658 may display a security insight event 646. The insight interface 658 includes a selectable control 663 that enables the user to switch between non-anonymized values 628b and anonymized values 628a. FIGS. 7A and 7B illustrate an insight interface 758 according to another aspect. The insight interface 758 displays a security insight event 746. Also, the insight interface 758 displays an LLM list 782 with a plurality of LLM identifiers 784 that correspond to different LLMs. A user may select one of the LLM identifiers 784 from the LLM list 782, which may cause the application to render the insight interface 758 of FIG. 7B, which includes a generate element 786. Selection of the generate element 786 may cause generation of the security insight events.

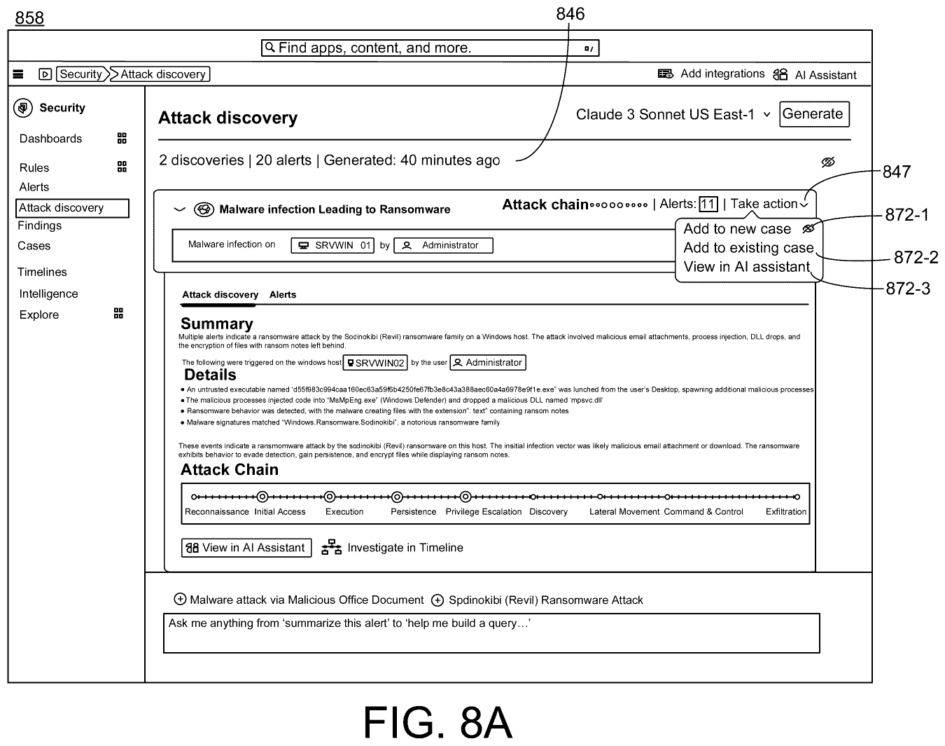

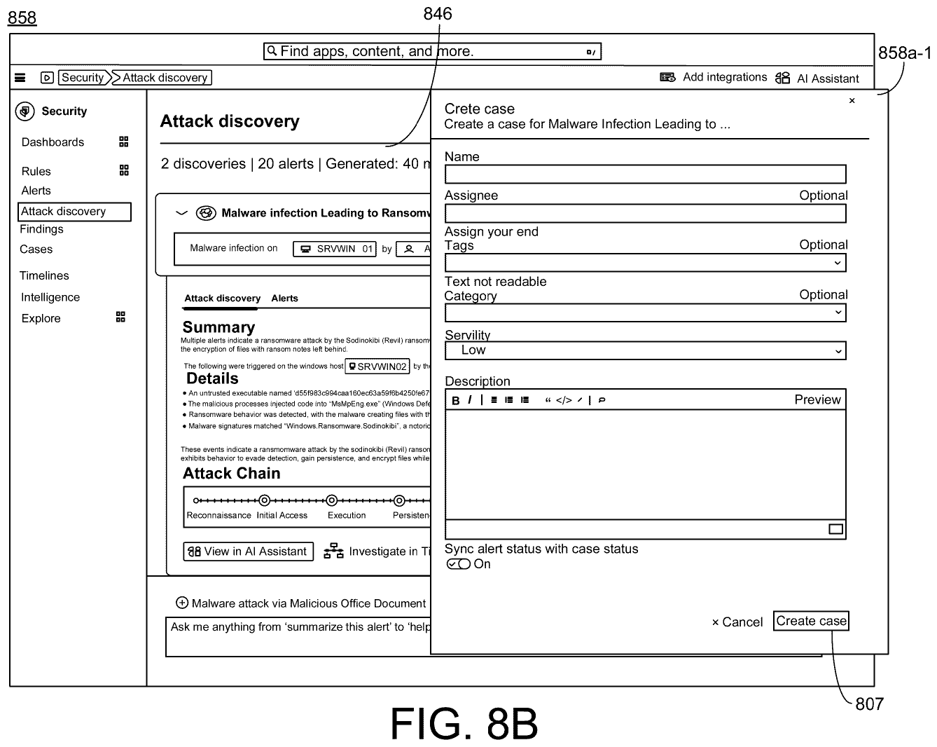

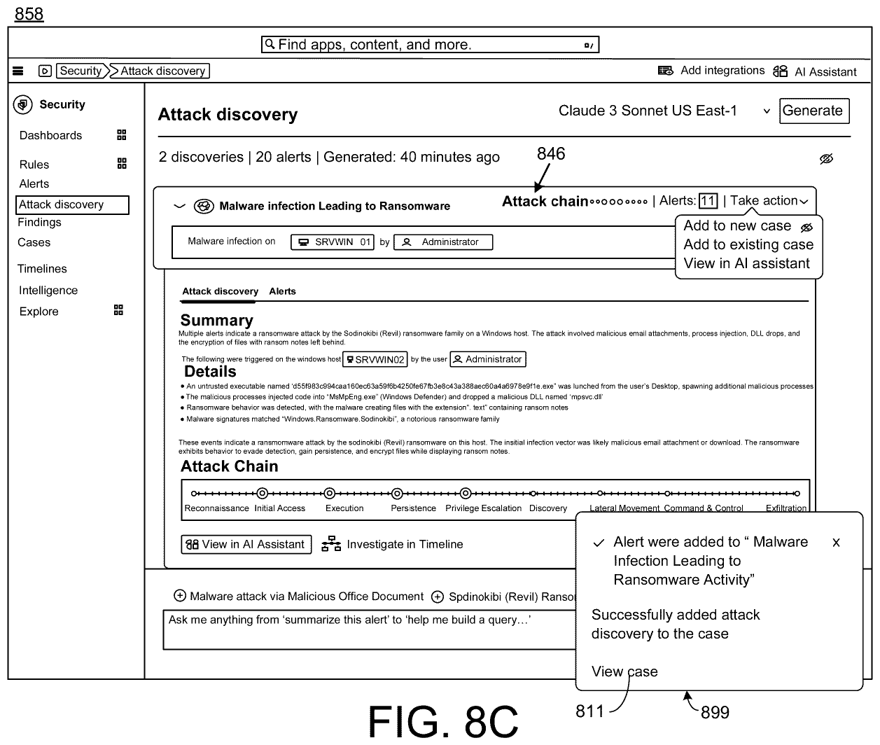

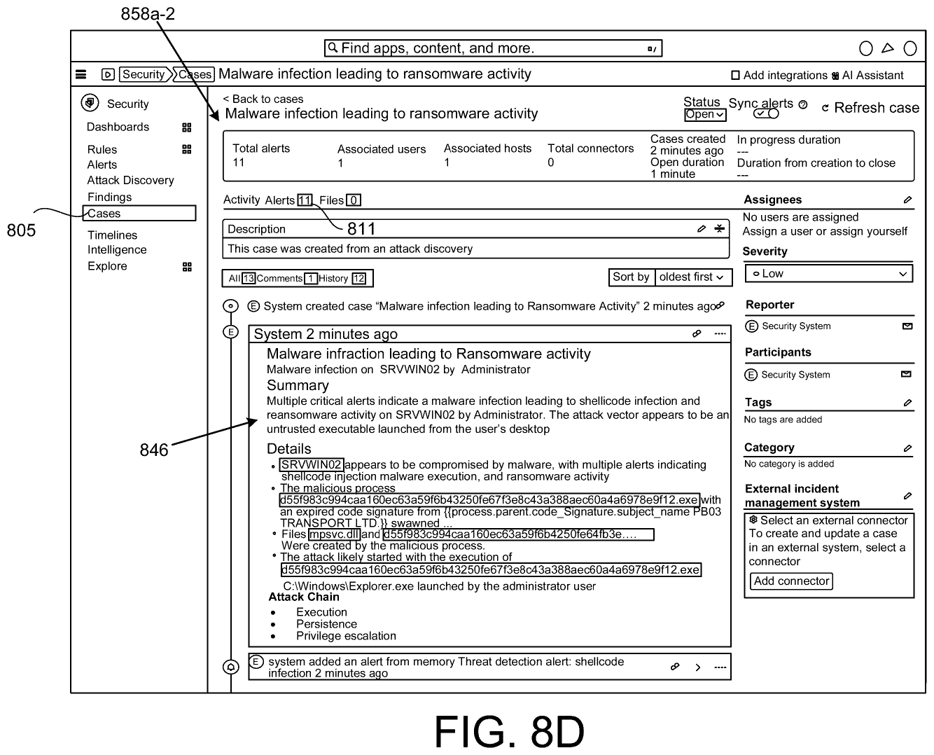

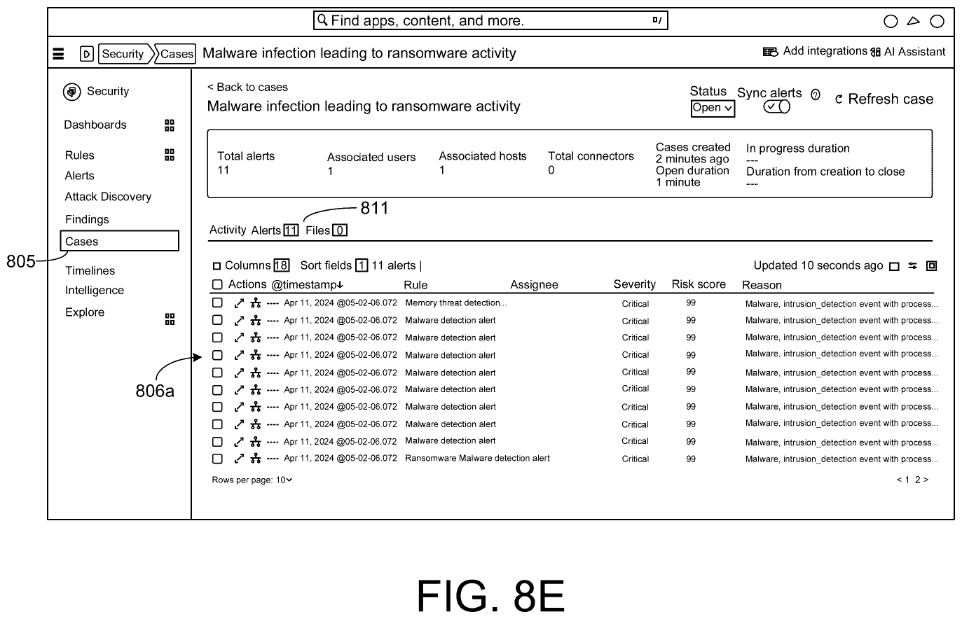

FIGS. 8A to 8E illustrate an insight interface 858 according to another aspect. The insight interface 858 may display a security insight event 846. In FIG. 8A, the security insight event 846 includes an action element 847, which, when selected, causes the display of an action item 872-1 (e.g., add to new case), an action item 872-2 (e.g., add to existing case), and an action item 872-3 (e.g., view in AI assistant). Selection of the action item 872-1 causes the display of an interface 858a-1 for creating a new case, as shown on FIG. 8B. The interface 858a-1 includes a create item 807, which, when selected, causes the display of a notification 899, as shown in FIG. 8C, indicating that a new case was created using the information from the security insight event 846. The notification 899 includes a selectable element 811, which, when selected, causes the display of interface 858a-2 associated with a case management system, as shown in FIG. 8D. The interface 858a-2 is a cases tab of the user interface. The interface 858a-2 was populated with information from the security insight event 846. In addition, the related security alerts associated with the security insight event 846 are added to the case. In some examples, the interface 858a-2 includes an alert element 811 that indicates the number of related security alerts associated with the case. Selection of the alert element 811 may display a list of the related security alerts 806a associated with the security insight event 846 in the cases tab 805.

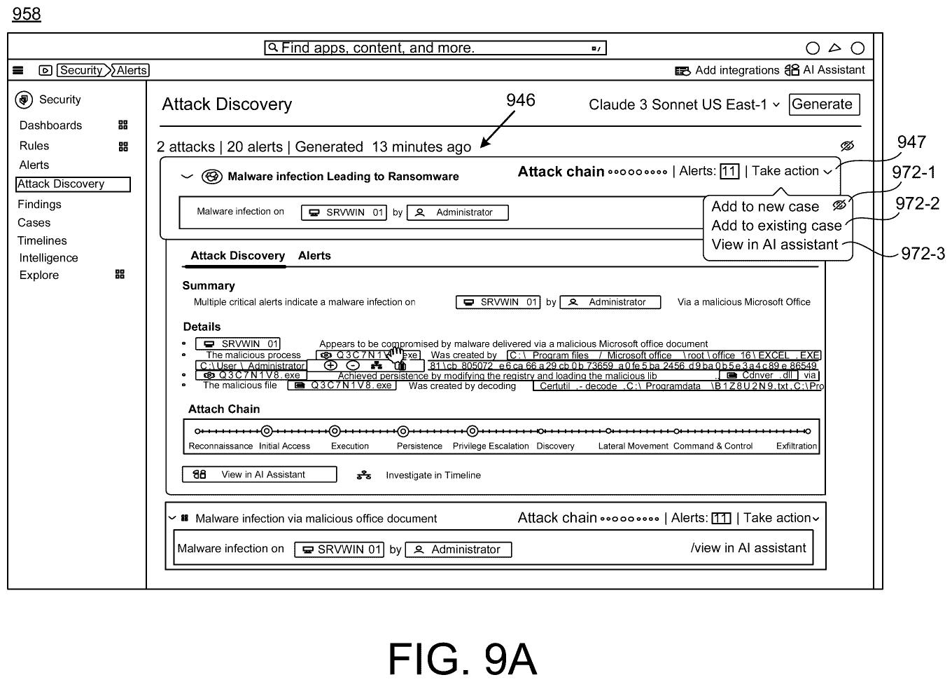

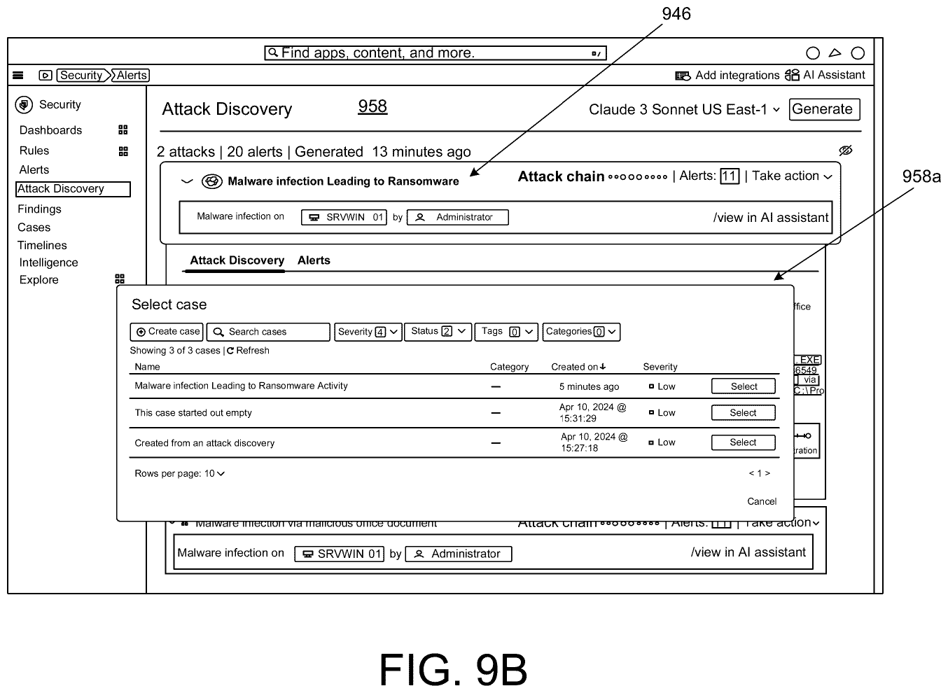

FIGS. 9A and 9B illustrate an insight interface 958 according to another aspect. The insight interface 958 may display a security insight event 946. In FIG. 9A, the security insight event 946 includes an action element 947, which, when selected, causes the display of an action item 972-1 (e.g., add to new case), an action item 972-2 (e.g., add to existing case), and an action item 972-3 (e.g., view in AI assistant). Selection of the action item 972-2 causes the display of an interface 958a for selecting adding the security insight event 946 to an existing case, as shown on FIG. 9B.

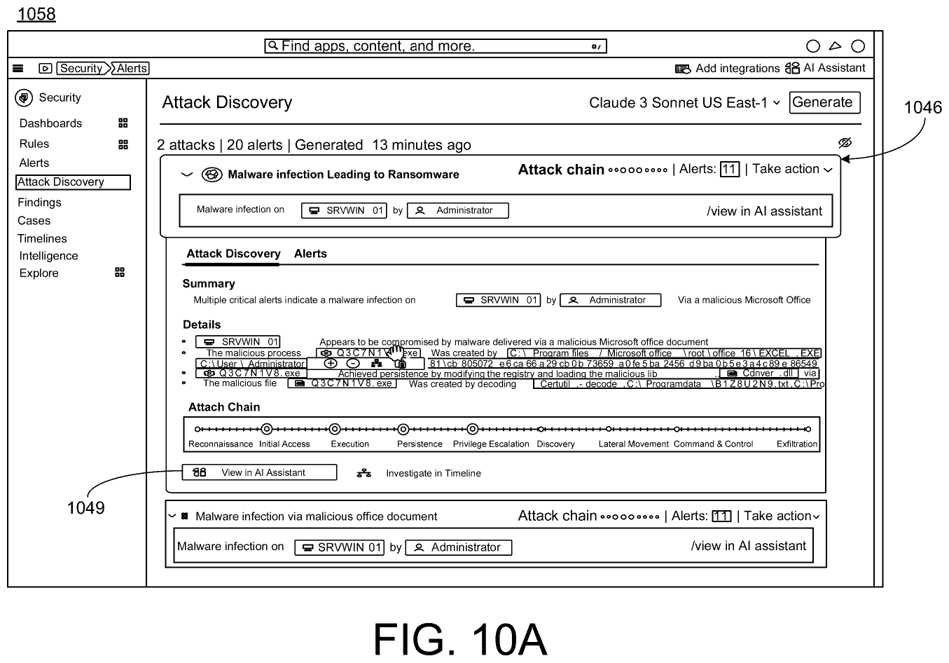

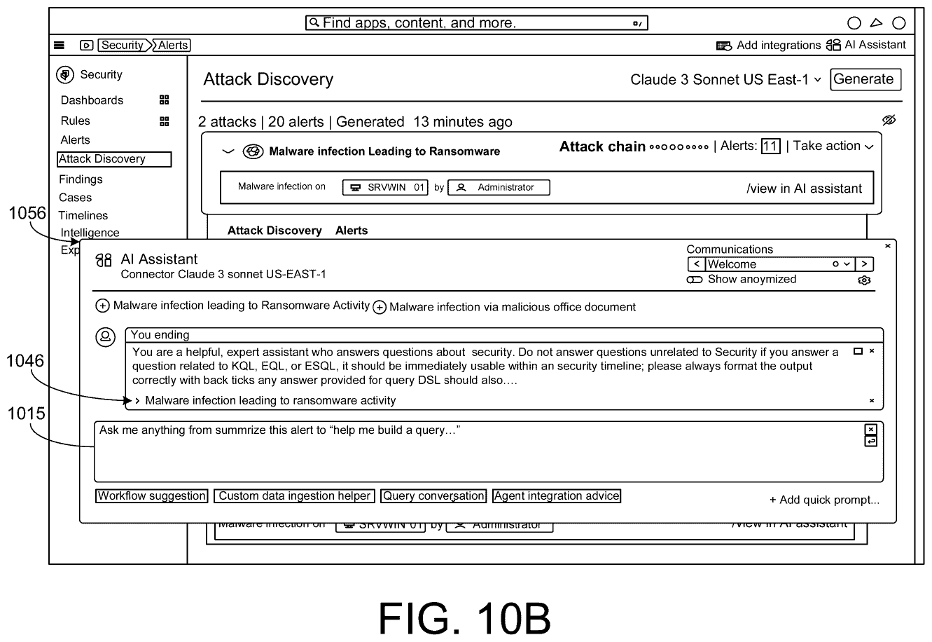

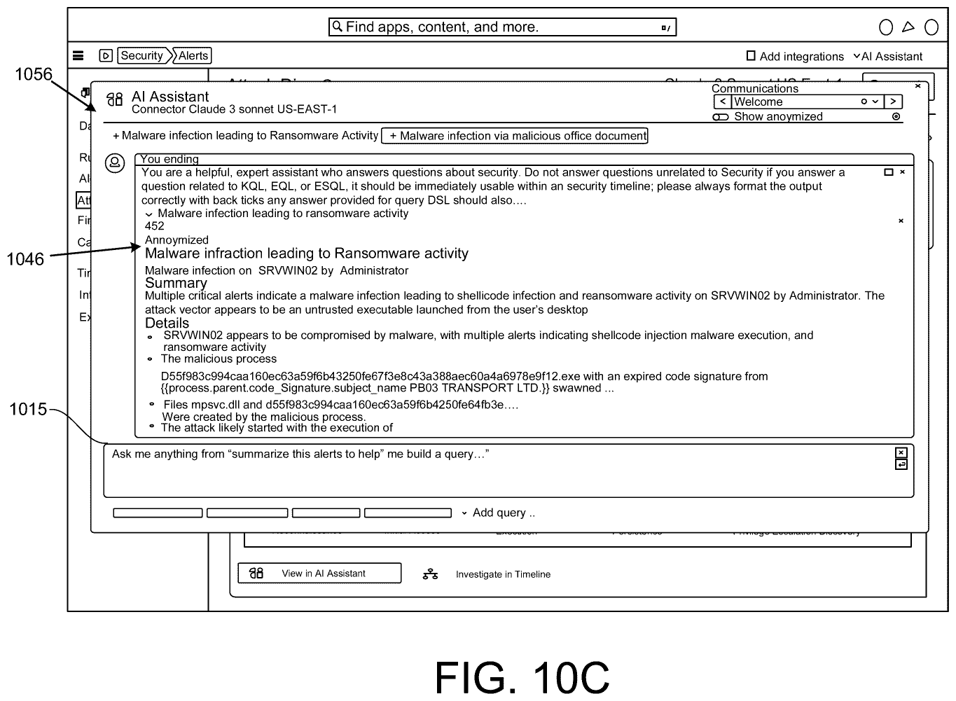

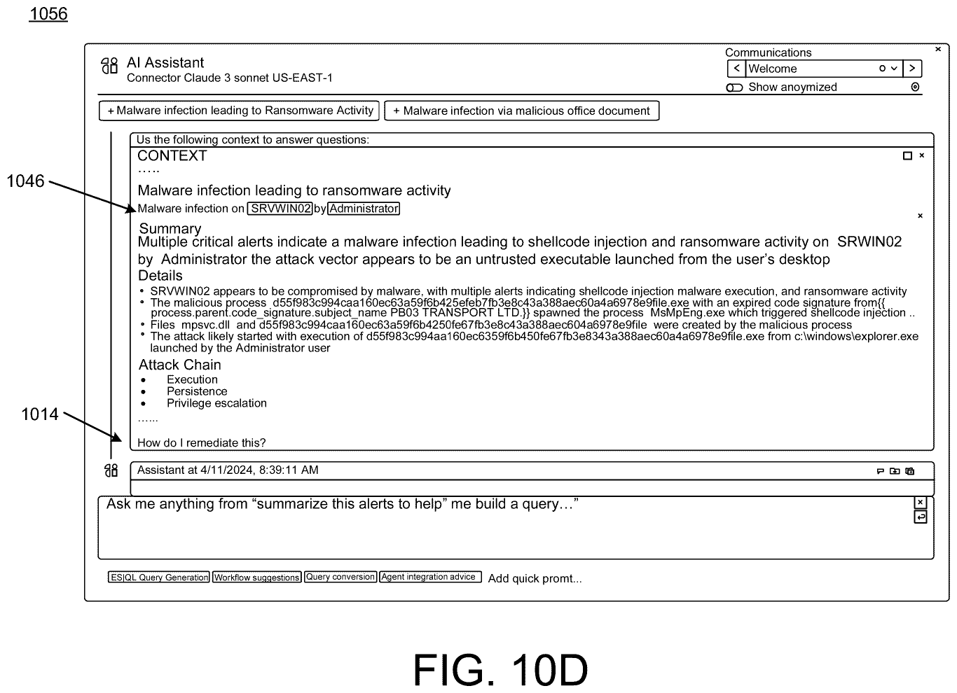

FIGS. 10A to 10D illustrate an insight interface 1058 according to another aspect. The insight interface 1058 may display a security insight event 1046. The security insight event 1046 includes a chat interface element 1049. The chat interface element 1049, when selected, is configured to render a chat interface 1056 as shown in FIG. 10B. The chat interface 1056 includes a prompt that includes information from the security insight event 1046 in a collapsed state. The chat interface 1056 includes an input field 1015 that receives a user query formulated by a user. Selection of the security insight event 1046 in the prompt may cause display of the security insight event 1046 in an expanded state, as shown in FIG. 10C. The user may use the chat interface 1056 to submit a user query 1014, and the security insight event 1046 is included in the prompt as context for the user query 1014. As shown in FIG. 10D, the security insight event 1046 is indicated as conversation chat history.

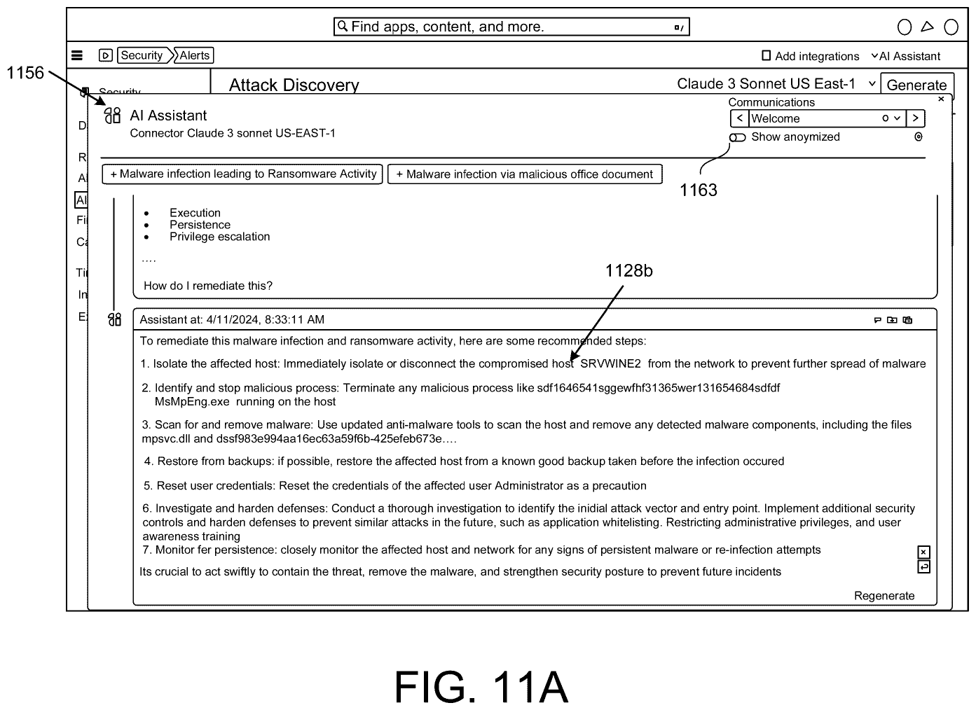

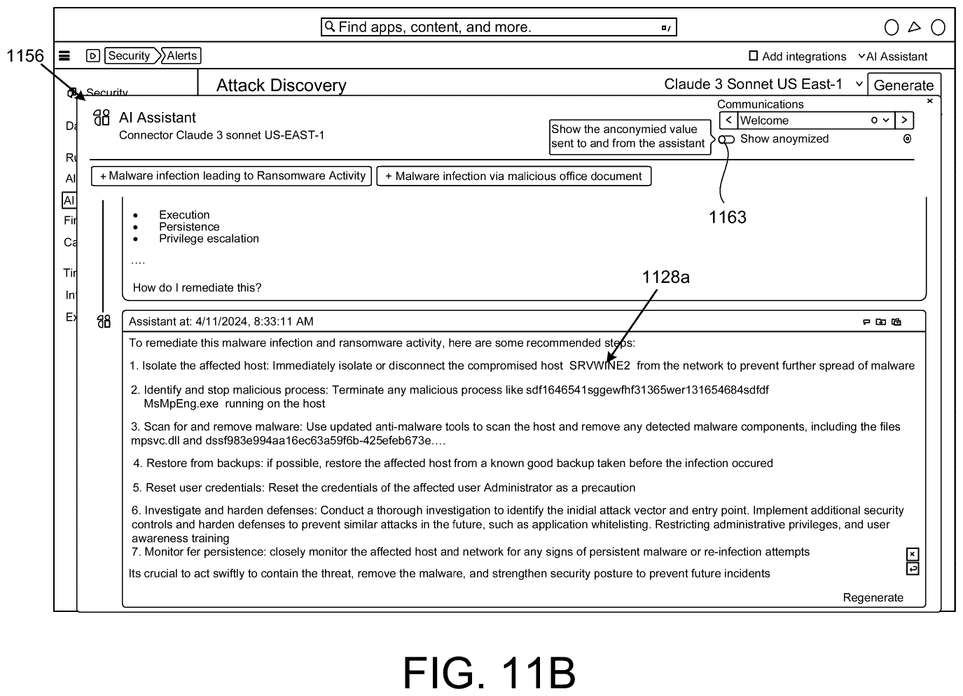

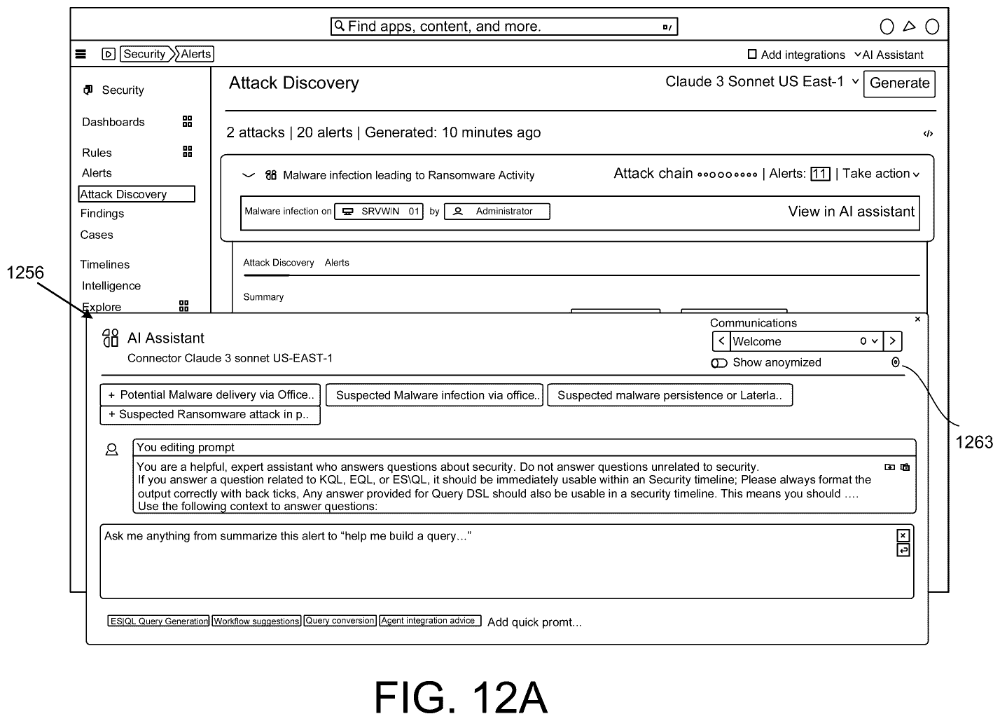

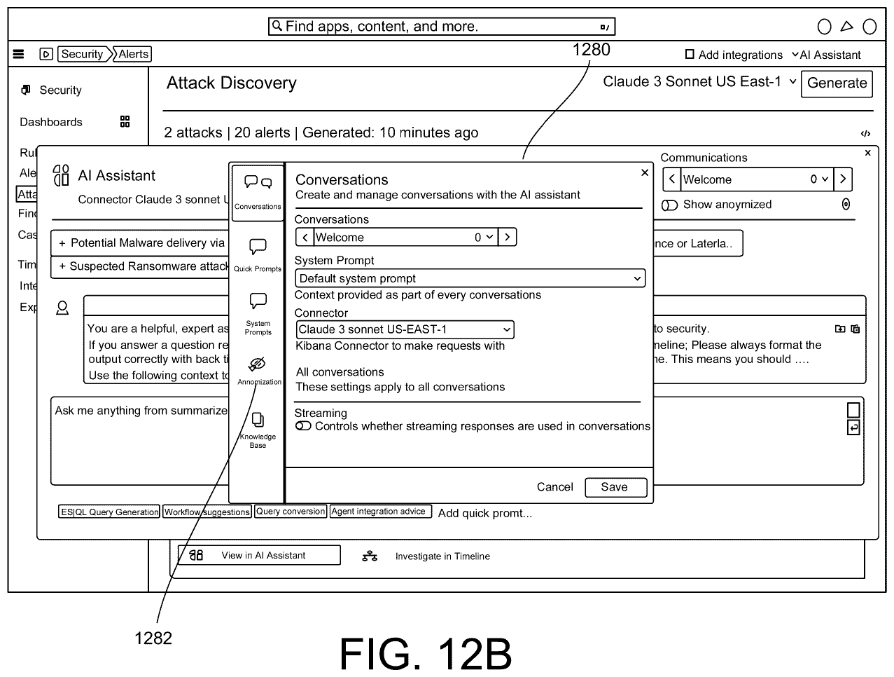

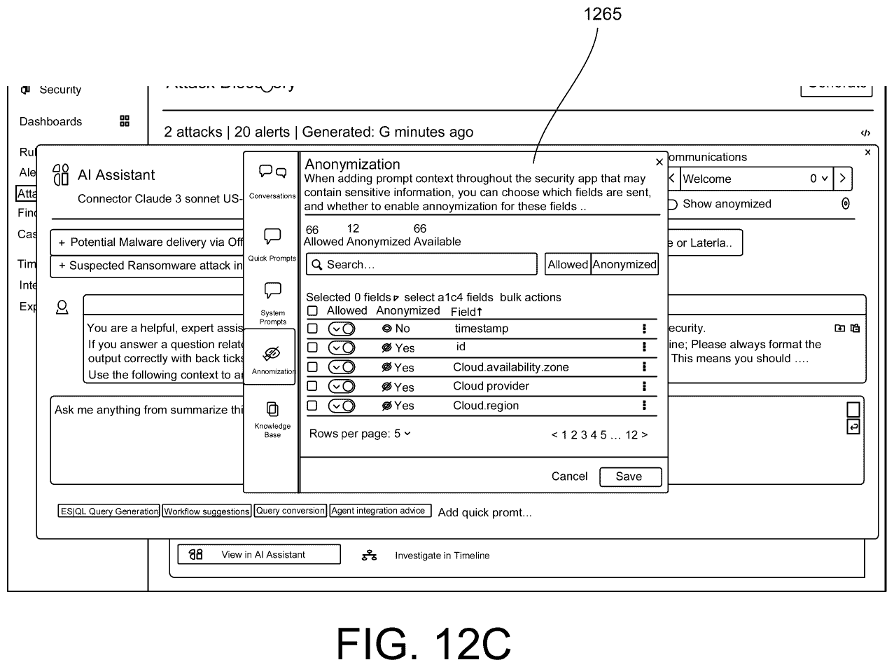

FIGS. 11A and 11B illustrate a chat interface 1156 according to another aspect. As shown in FIGS. 11A and 11B, the chat interface 1156 includes a selectable element 1163 that enables the user to switch between non-anonymized values 1128b and anonymized values 1128a. FIGS. 12A to 12C illustrate a chat interface 1256 according to another aspect. The chat interface 1256 may identify security insight events and may select one or more of the security insight events to be added to the chat prompt. The chat interface 1256 includes a setting icon 1263. The setting icon 1263, when selected, causes the display of interface 1280 with configurable settings associated with AI chat conversations. The interface 1280 may include an anonymization interface element 1282, which, when selected, displays a setting interface 1265 that enables a user to adjust one or more settings for anonymizing data. The setting interface 1265 includes a plurality of rows, where each row corresponds to a separate field with a selectable control to enable or disable anonymization with respect to that field and a status field that indicates the status of the anonymization.

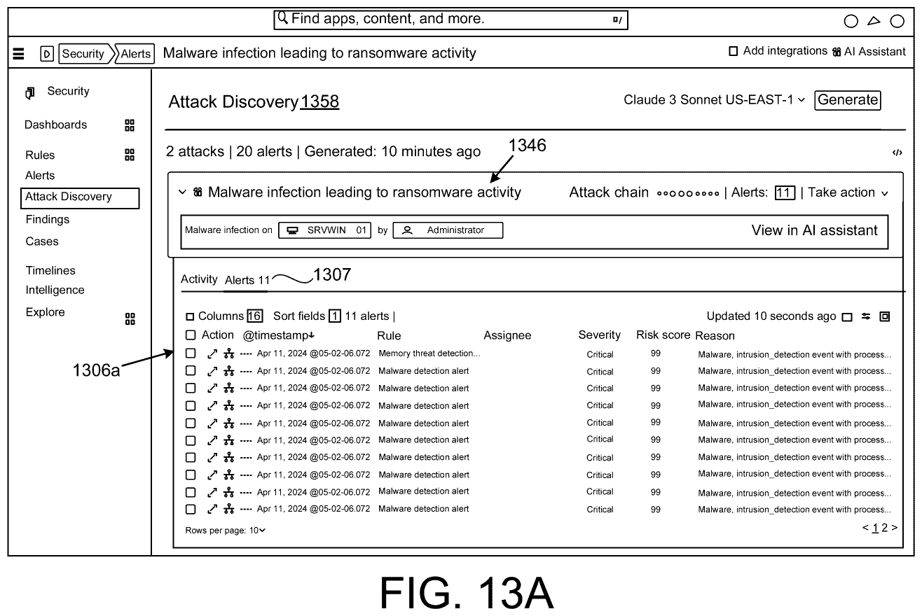

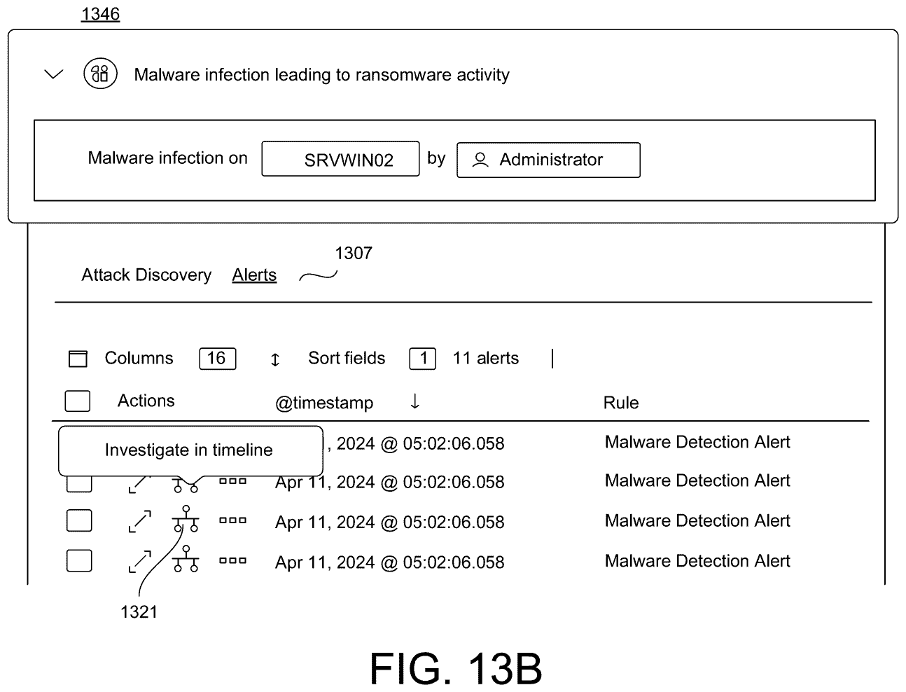

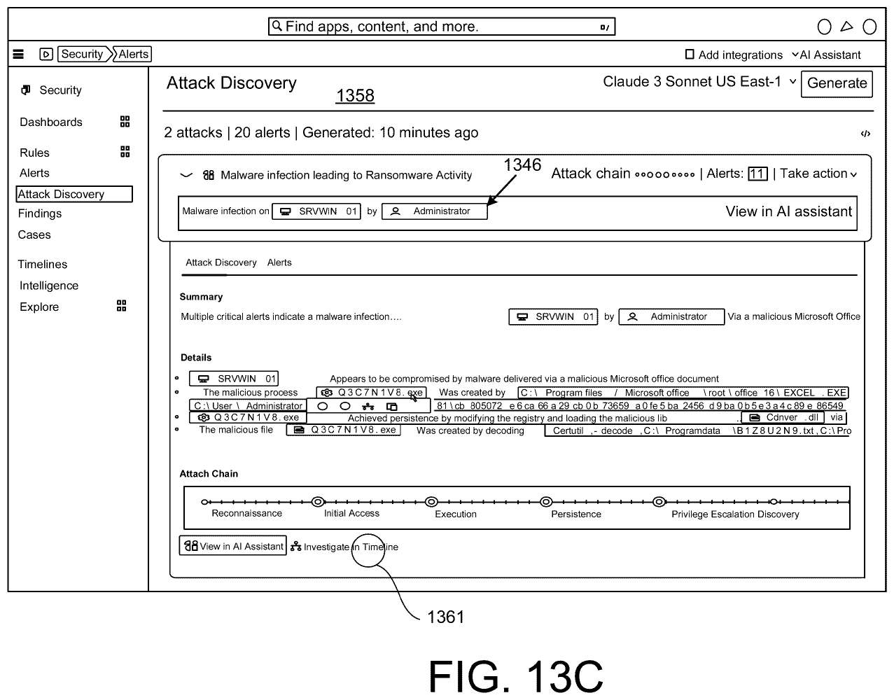

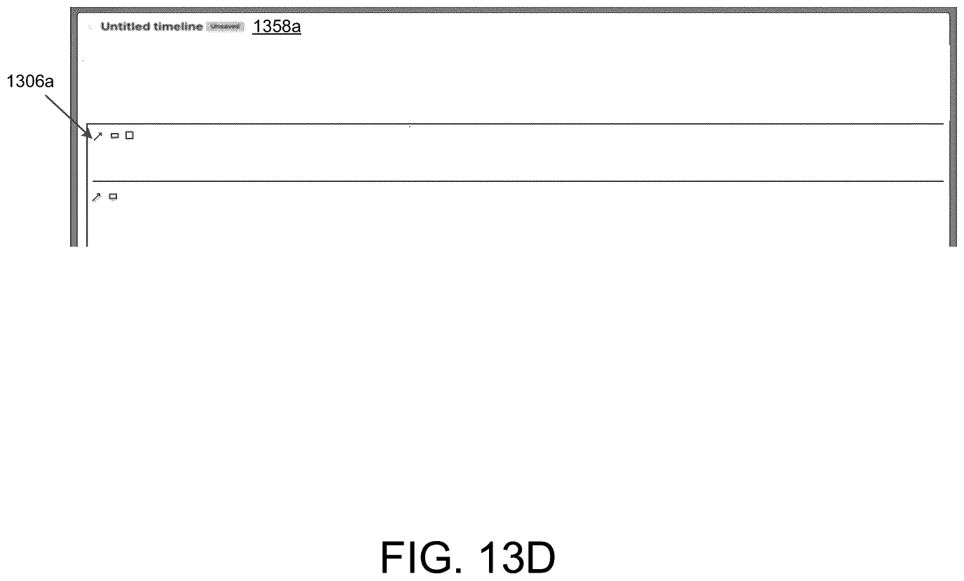

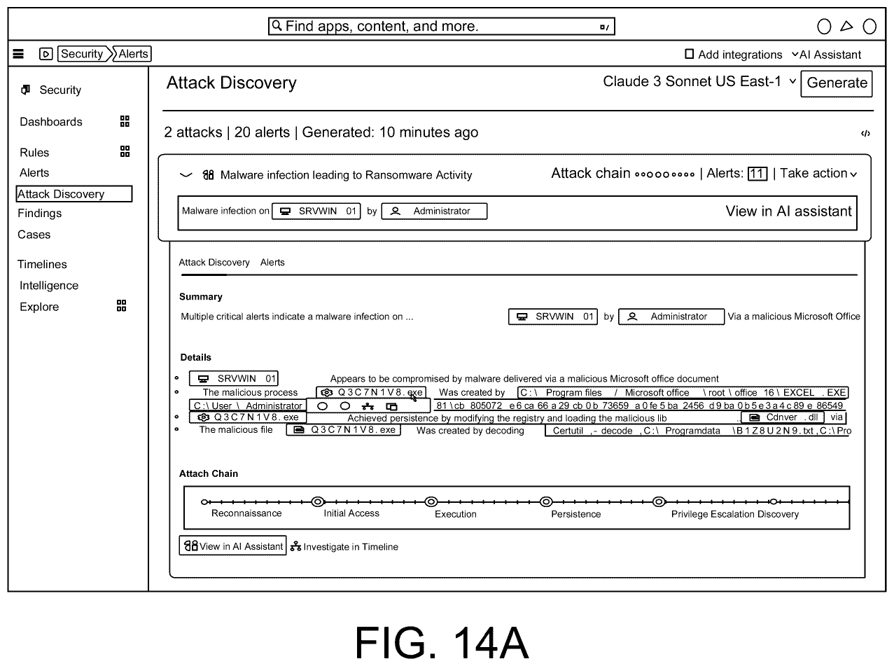

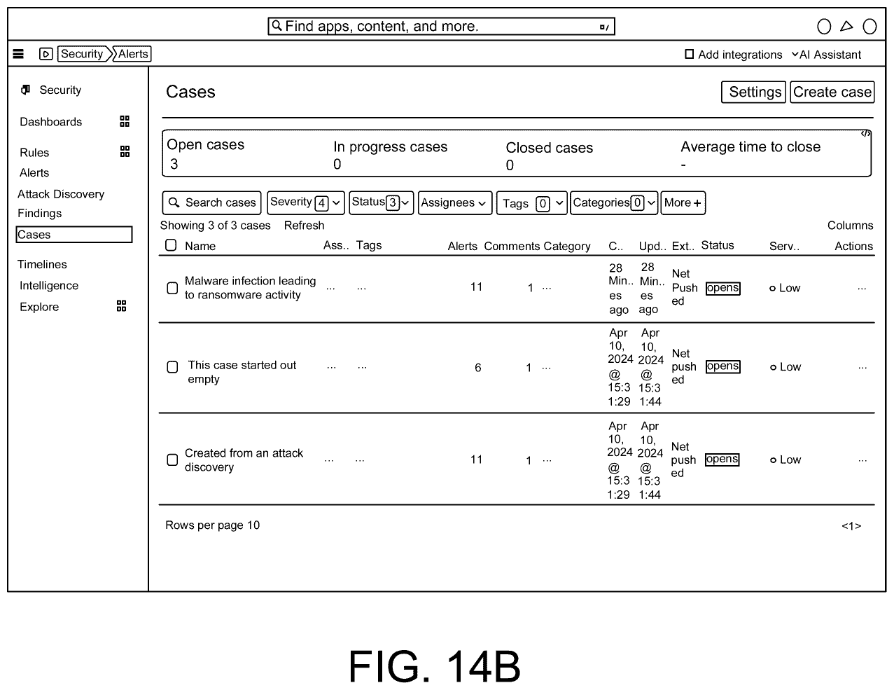

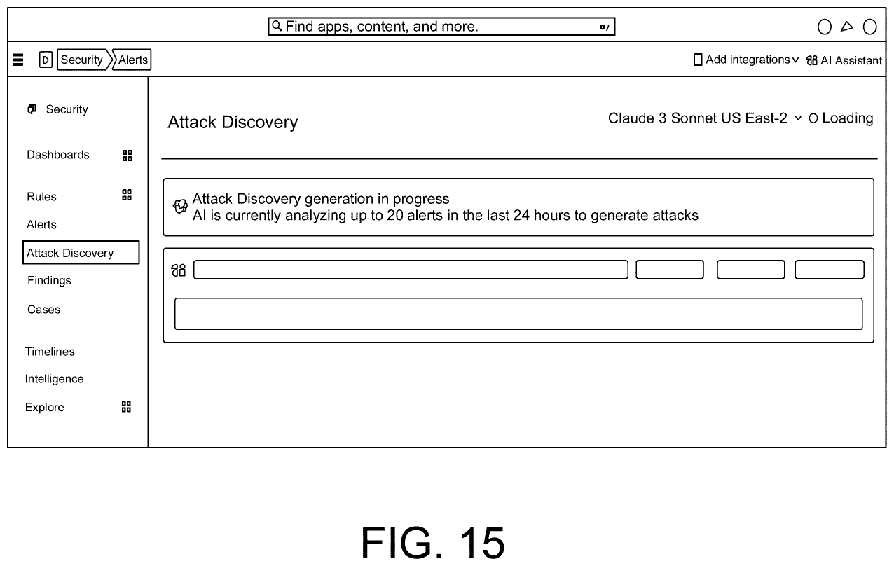

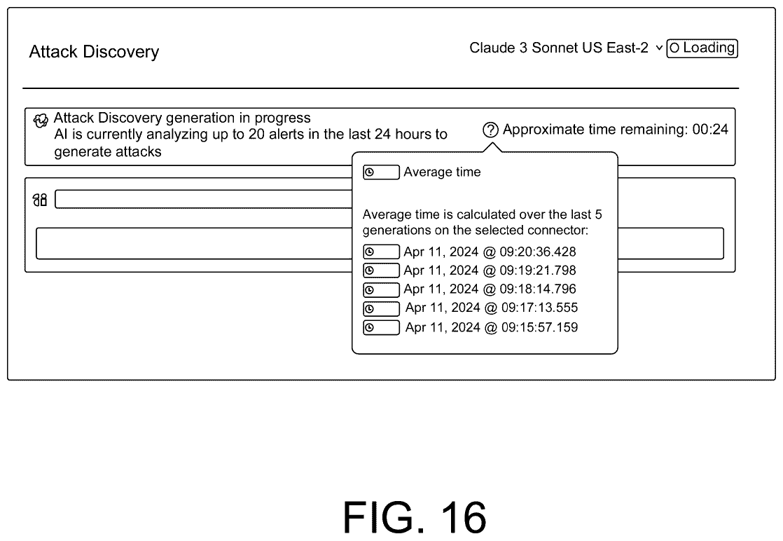

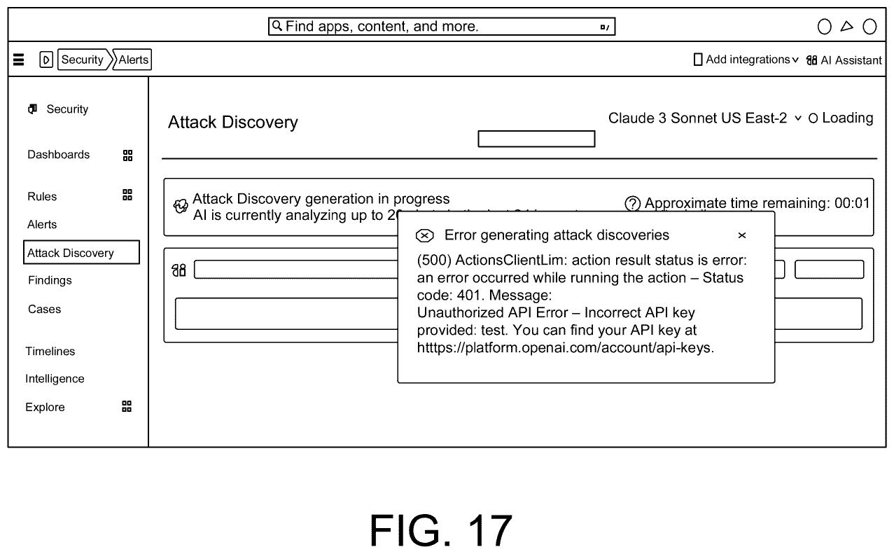

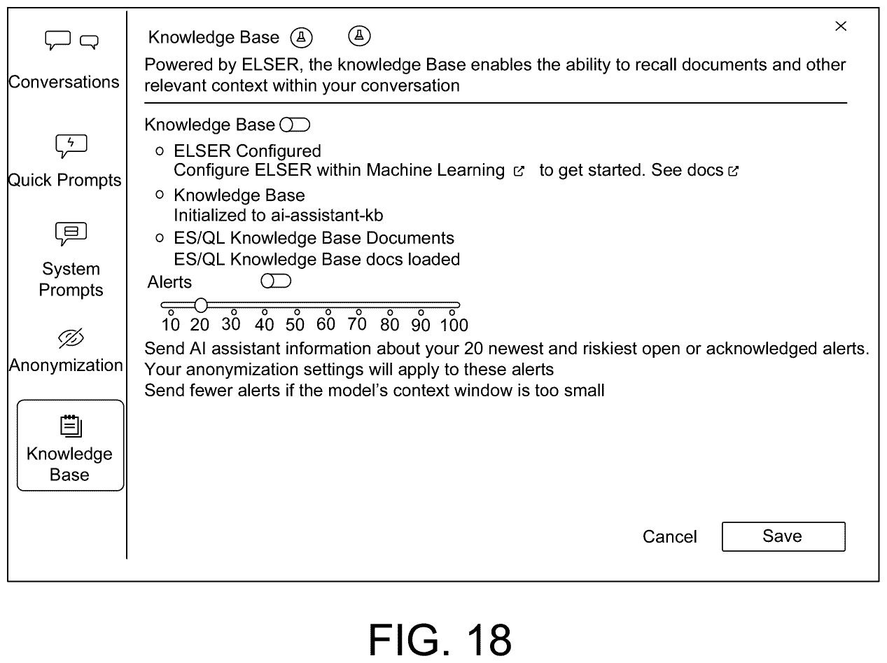

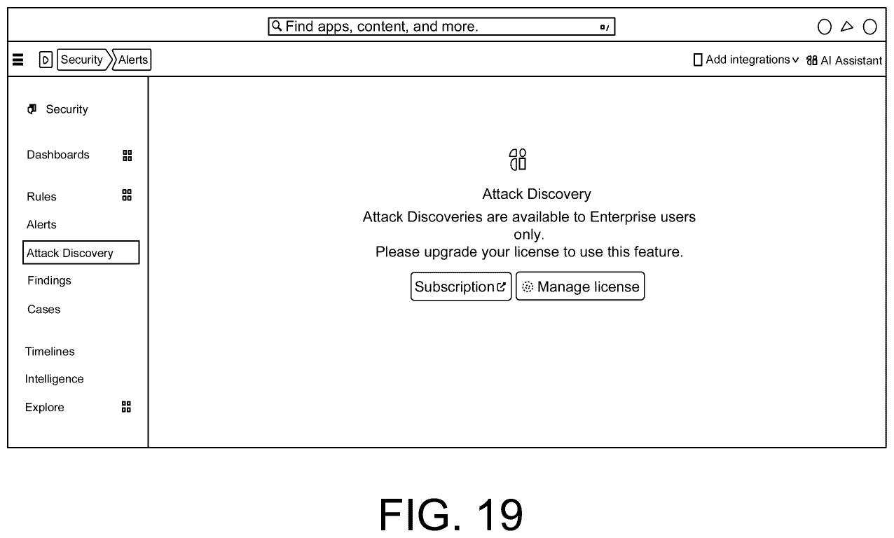

FIGS. 13A to 13D illustrate an insight interface 1358 according to another aspect. The insight interface 1358 includes an alert tab 1307 that displays related security alerts 1306a associated with a security insight event 1346. As shown in FIG. 13B, the alert tab 1307 displays action items associated with each related security alert 1306a, where one of the action items is a first timeline action item 1321. As shown in FIG. 13B, the insight tab displays a security insight event 1346, where the security insight event 1346 includes a second timeline action item 1361. Selection of either the first timeline action item 1321 or the second timeline action item 1361 causes a display of a timeline interface 1358a that is populated with the related security alerts 1306a associated with the security insight event 1346, as shown in FIG. 13D. FIGS. 14A and 14B and FIGS. 15 to 19 illustrate various other interfaces associated with a security system.

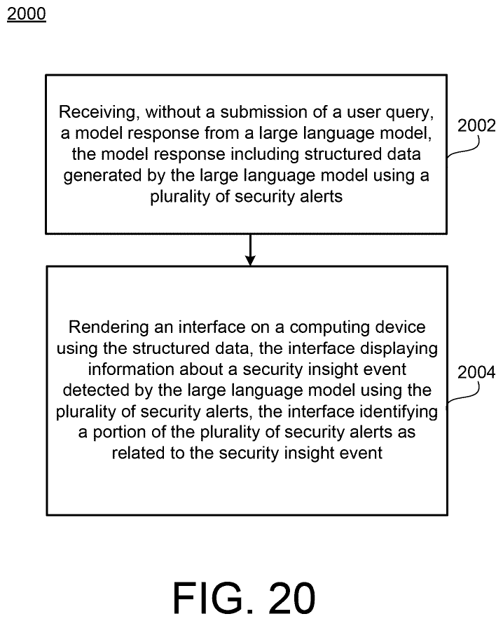

FIG. 20 is a flowchart 2000 depicting example operations of a security system. The example operations of FIG. 20 may be executed by the security system 100 of FIGS. 1A to 1K and may be used to generate any of the user interfaces shown in FIGS. 2A to 19. The flowchart 2000 may depict operations of a computer-implemented method. Although the flowchart 2000 of FIG. 20 illustrates the operations in sequential order, it will be appreciated that this is merely an example, and that additional or alternative operations may be included. Further, operations of FIG. 20 and related operations may be executed in a different order than that shown, or in a parallel or overlapping fashion.

Operation 2002 includes receiving, without a submission of a user query, a model response from a large language model, the model response including structured data generated by the large language model using a plurality of security alerts. Operation 2004 includes rendering an interface on a computing device using the structured data, the interface displaying information about a security insight event detected by the large language model using the plurality of security alerts, the interface identifying a portion of the plurality of security alerts as related to the security insight event.

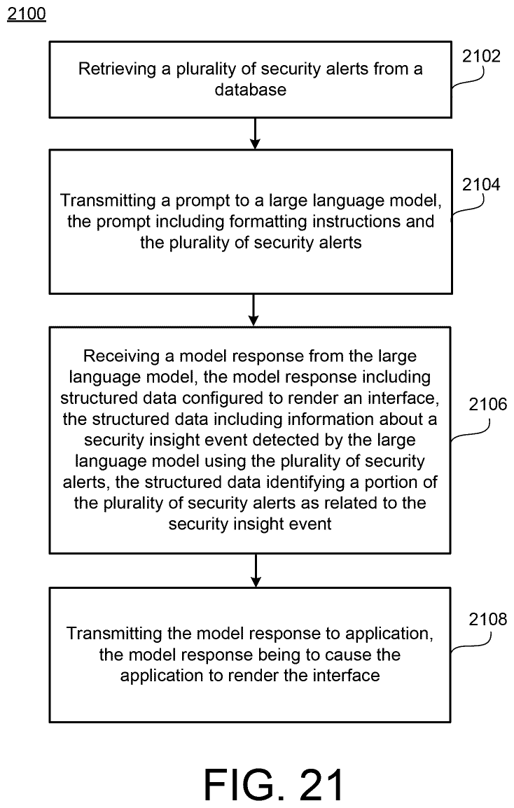

FIG. 21 is a flowchart 2100 depicting example operations of a security system. The example operations of FIG. 21 may be executed by the security system 100 of FIGS. 1A to 1K and may be used to generate any of the user interfaces shown in FIGS. 2A to 19. The flowchart 2100 may depict operations of a computer-implemented method. Although the flowchart 2100 of FIG. 21 illustrates the operations in sequential order, it will be appreciated that this is merely an example, and that additional or alternative operations may be included. Further, operations of FIG. 21 and related operations may be executed in a different order than that shown, or in a parallel or overlapping fashion.

Operation 2102 includes retrieving a plurality of security alerts from a database. Operation 2104 includes transmitting a prompt to a large language model, the prompt including formatting instructions and the plurality of security alerts. Operation 2106 includes receiving a model response from the large language model, the model response including structured data configured to render an interface, the structured data including information about a security insight event detected by the large language model using the plurality of security alerts, the structured data identifying a portion of the plurality of security alerts as related to the security insight event. Operation 2108 includes transmitting the model response to application, the model response being to cause the application to render the interface.

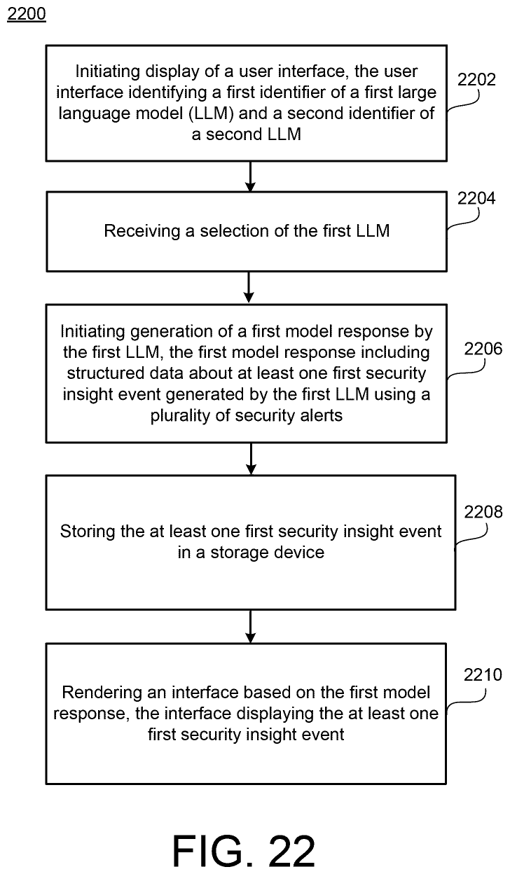

FIG. 22 is a flowchart 2200 depicting example operations of a security system. The example operations of FIG. 22 may be executed by the security system 100 of FIGS. 1A to 1K and may be used to generate any of the user interfaces shown in FIGS. 2A to 19. The flowchart 2200 may depict operations of a computer-implemented method. Although the flowchart 2200 of FIG. 22 illustrates the operations in sequential order, it will be appreciated that this is merely an example, and that additional or alternative operations may be included. Further, operations of FIG. 22 and related operations may be executed in a different order than that shown, or in a parallel or overlapping fashion.

Operation 2202 includes initiating display of a user interface, the user interface identifying a first identifier of a first large language model (LLM) and a second identifier of a second LLM. Operation 2204 includes receiving a selection of the first LLM. Operation 2206 includes initiating generation of a first model response by the first LLM, the first model response including structured data about at least one first security insight event generated by the first LLM using a plurality of security alerts. Operation 2208 includes storing the at least one first security insight event in a storage device. Operation 2210 includes rendering an interface based on the first model response, the interface displaying the at least one first security insight event.

In an enterprise or cloud-based computing environment, modern security operations centers (SOCs) face significant challenges in distinguishing genuine security threats from vast volumes of noisy, heterogeneous alert data. Conventional systems often use manually defined correlation rules or heuristics that lack adaptability and result in high false positive rates. These solutions also fail to uncover latent or cross-domain threat indicators that would otherwise remain undetected. The security system discussed herein provides a technical solution to this problem by using a large language model (LLM) within a structured AI pipeline to analyze incoming security alerts and generate a security insight event. This event encapsulates a deduplicated, contextually enriched, and semantically understood representation of one or more security alerts that may otherwise be missed in conventional systems.

The security system discussed herein includes a prompt-based AI architecture wherein the insight prompt is dynamically constructed based on structured and unstructured alert attributes. The prompt includes technical context such as alert source, severity, correlated timeframes, entity identifiers (e.g., IP, user ID), and optionally prior system behavior logs. This prompt is not static text but rather a structured composite input that allows the LLM to resolve semantic ambiguity and generate accurate, context-specific outputs. This technical configuration may ensure the LLM functions not just as a text generator, but as a pattern recognition engine operating over time-stamped system telemetry. In some examples, the attack discovery process is enhanced for security-specific event types. The system uses a feedback loop whereby the system administrator or SOC analyst labels insight events as correct or incorrect. These labels are logged, and the prompt construction logic is adjusted based on validation feedback, refining the mapping from raw alerts to insight events over time. While the LLM itself may be pre-trained, the prompt-engineering pipeline and feedback-tuned prompting constitutes a technical application that enables the LLM to detect threats that conventional systems or generic LLMs would not reliably identify.

Training an LLM to identify security insights may involve adapting the model to understand, correlate, and reason over heterogeneous security data (e.g., logs, alerts, metadata). While most LLMs are pretrained on general corpora, the LLMs can be tailored to security use cases using fine-tuning, prompt engineering, or retrieval-augmented generation (RAG). Some training techniques are identified below. The security system may adapt one or more of the following techniques.

The security system may adjust the LLM by fine-tuning based on security-specific corpora. The data source may include historical alert data, security incident reports, threat intelligence feeds, analyst notes, and attack data. The process may include curate examples where multiple alerts map to a common root cause or incident, annotate them with human expert-generated insights (e.g., “these 4 alerts relate to lateral movement of malware X.”), and fine-tune the LLM (or a distilled version) using supervised learning to predict insight events from grouped alert sequences. As a result, the model may learn structured relationships between alerts, timing, and high-level security narratives.

In some examples, the security system may adjust the LLM based on instruction tuning or prompt tuning for security context. In some examples, the security system uses a few-shot prompting with carefully crafted prompts that include structured alert data and a desired output format. In some examples, the security system may further improve with instruction-tuned models adapted to security scenarios (e.g., “Given these alerts, explain whether this is a coordinated attack.”)

In some examples, the security system may adjust the LLM based on retrieval-augmented generation (RAG) with security knowledge base (e.g., from the vector database 108a). The LLM may be augmented with a retrieval layer that pulls in relevant security documents, knowledge graphs, or prior analyst assessments at inference time. Given a new alert set, the system retrieves similar past cases and feeds both into the LLM to generate insights. The model may benefit from dynamic context loading, reducing the reliance on static training data.

In some examples, the security system may adjust the LLM based on multi-modal feature ingestion. In some examples, the security system may include structured fields (e.g., timestamps, severity, IP addresses) and unstructured text (alert descriptions) in prompt templates. Then, the security system may use preprocessing layers to convert event logs into semantically rich prompt components. This training approach may provide a technical benefit of allowing the LLM to reason across structured and instructed input.

In some examples, the security system may adjust the LLM based on reinforcement via analyst feedback. In some examples, the security system may include a feedback loop in which analysts approve or correct insight events, and these corrections are logged and used to refine prompt construction or training samples. This adaptive tuning may build domain-specific intelligence without fully retraining the LLM.

The security system discussed herein provides a technical solution to a technical problem encountered in modern cybersecurity operations: namely, how to process high volumes of heterogeneous, time-sensitive, and often semantically ambiguous security alerts in a manner that enables timely and accurate identification of security threats. Traditional rule-based systems or basic correlation engines are inadequate, frequently overwhelmed by noise, incapable of identifying subtle cross-domain attacks, and prone to false positives. The security system discussed herein addresses these deficiencies through a technically structured application of a large language model (LLM), configured to receive, process, and synthesize a set of alerts into a unified, actionable security insight event.

A core technical effect arises from the automated transformation of low-level machine telemetry and structured alert data into a condensed, semantically rich representation that maps to a likely root cause or higher-order threat pattern. This transformation is not mere summarization; it reflects a context-aware reasoning process enabled by the LLM's ability to interpret technical alert attributes, correlate temporal and causal signals, and produce outputs optimized for machine-actionable follow-up. As such, the invention improves the technical functioning of the underlying security system by reducing analyst workload, system response latency, and alert fatigue, while increasing true positive detection rates.

Another technical effect stems from the architecture of the insight prompt, which is dynamically constructed from structured security data such as IP addresses, threat scores, technique identifiers, timestamps, and prior event history. This structured input allows the LLM to be applied not generically, but in a security-specific technical context that is tailored to the domain's operational semantics. The prompt serves as a form of real-time inference programming-encoding relationships between telemetry events in a way that maximizes the LLM's ability to identify meaningful correlations that static systems cannot detect. Moreover, the system includes a human-in-the-loop feedback mechanism wherein analyst-provided feedback on the relevance, accuracy, or utility of the insight event is retained and used to modify subsequent prompt generation. This creates a self-adapting AI pipeline that enhances the accuracy of insight generation over time without necessitating full retraining of the LLM. This feedback loop produces an ongoing technical effect by improving insight fidelity, reducing false positives, and aligning outputs with the real-world structure of attacks and response workflows. In some examples, by applying the LLM in this highly structured, domain-specific manner, the security system discussed herein does not merely present information but rather performs a technical processing step that transforms raw telemetry data into an actionable object (the insight event), thereby enhancing the technical capabilities of the security monitoring system itself.

Clause 1. A method comprising: retrieving a plurality of security alerts from a database; transmitting a prompt to a large language model, the prompt including formatting instructions and the plurality of security alerts; receiving a model response from the large language model, the model response including structured data configured to render an interface, the structured data including information about a security insight event detected by the large language model using the plurality of security alerts, the structured data identifying a portion of the plurality of security alerts as related to the security insight event; and transmitting the model response to application, the model response being to cause the application to render the interface.

Clause 2. The method of clause 1, further comprising: generating anonymized security alerts from the plurality of security alerts by converting a non-anonymized value of an entity mentioned in a security alert to an anonymized value, wherein the anonymized security alerts are included in the prompt.

Clause 3. The method of clause 1 or 2, wherein the plurality of security alerts retrieved from the database include a first format, the method further comprising: converting the plurality of security alerts from the first format to a second format, the plurality of security alerts with the second format being included in the prompt.

Clause 4. The method of any one of clauses 1 to 3, further comprising: determining whether the model response achieves a formatting structure defined by the formatting instructions; and in response to the model response being determined as achieving the formatting structure defined by the formatting instructions, transmitting the model response to the application.

Clause 5. The method of any one of clauses 1 to 4, wherein the structured data defines a computer object for the security insight event, the computer object configured to be expanded or collapsed.

Clause 6. The method of clause 5, wherein the computer object includes a selectable element of an entity mentioned in the security insight event, the selectable element, when selected, configured to render an entity page.

Clause 7. The method of any one of clauses 1 to 6, further comprising: receiving a selection of an identifier associated with the large language model; obtaining a connector that corresponds to the identifier associated with the large language model; and transmitting the prompt using the connector.

Clause 8. The method of clause 7, wherein the large language model is a first large language model and the connector is a first connector, the method further comprising: receiving a selection of an identifier associated with a second large language model; obtaining a second connector that corresponds to the identifier associated with the second large language model; and transmitting the prompt using the second connector.

Clause 9. An apparatus comprising: at least one processor; and a non-transitory computer-readable medium storing executable instructions that cause the at least one processor to execute operations, the operations comprising: retrieving a plurality of security alerts from a database; transmitting a prompt to a large language model, the prompt including formatting instructions and the plurality of security alerts; receiving a model response from the large language model, the model response including structured data configured to render an interface, the structured data including information about a security insight event detected by the large language model using the plurality of security alerts, the structured data identifying a portion of the plurality of security alerts as related to the security insight event; and transmitting the model response to application, the model response being to cause the application to render the interface.

Clause 10. The apparatus of clause 9, wherein the operations further comprise: generating anonymized security alerts from the plurality of security alerts by converting a non-anonymized value of an entity mentioned in a security alert to an anonymized value, wherein the anonymized security alerts are included in the prompt.

Clause 11. The apparatus of clause 9 or 10, wherein the plurality of security alerts retrieved from the database include a first format, wherein the operations further comprise: converting the plurality of security alerts from the first format to a second format, the plurality of security alerts with the second format being included in the prompt.

Clause 12. The apparatus of any one of clauses 9 to 11, wherein the operations further comprise: determining whether the model response achieves a formatting structure defined by the formatting instructions; and in response to the model response being determined as achieving the formatting structure defined by the formatting instructions, transmitting the model response to the application.

Clause 13. The apparatus of any one of clauses 9 to 12, wherein the structured data defines a computer object for the security insight event, the computer object configured to be expanded or collapsed, wherein the computer object includes a selectable element of an entity mentioned in the security insight event, the selectable element, when selected, configured to render an entity page.

Clause 14. The apparatus of any one of clauses 9 to 13, wherein the operations further comprise: receiving a selection of an identifier associated with the large language model; obtaining a connector that corresponds to the identifier associated with the large language model; and transmitting the prompt using the connector.

Clause 15. The apparatus of clause 14, wherein the large language model is a first large language model and the connector is a first connector, wherein the operations further comprise: receiving a selection of an identifier associated with a second large language model; obtaining a second connector that corresponds to the identifier associated with the second large language model; and transmitting the prompt using the second connector.

Clause 16. A non-transitory computer-readable medium storing executable instructions that when executed by at least one processor cause the at least one processor to execute operations, the operations further comprising: retrieving a plurality of security alerts from a database; transmitting a prompt to a large language model, the prompt including formatting instructions and the plurality of security alerts; receiving a model response from the large language model, the model response including structured data configured to render an interface, the structured data including information about a security insight event detected by the large language model using the plurality of security alerts, the structured data identifying a portion of the plurality of security alerts as related to the security insight event; and transmitting the model response to application, the model response being to cause the application to render the interface.

Clause 17. The non-transitory computer-readable medium of clause 16, wherein the operations further comprise: generating anonymized security alerts from the plurality of security alerts by converting a non-anonymized value of an entity mentioned in a security alert to an anonymized value, wherein the anonymized security alerts are included in the prompt.

Clause 18. The non-transitory computer-readable medium of clause 16 or 17, wherein the plurality of security alerts retrieved from the database include a first format, wherein the operations further comprise: converting the plurality of security alerts from the first format to a second format, the plurality of security alerts with the second format being included in the prompt.

Clause 19. The non-transitory computer-readable medium of any one of clauses 16 to 18, wherein the operations further comprise: determining whether the model response achieves a formatting structure defined by the formatting instructions; and in response to the model response being determined as achieving the formatting structure defined by the formatting instructions, transmitting the model response to the application.

Clause 20. The non-transitory computer-readable medium of any one of clauses 16 to 19, wherein the structured data defines a computer object for the security insight event, the computer object configured to be expanded or collapsed, wherein the computer object includes a selectable element of an entity mentioned in the security insight event, the selectable element, when selected, configured to render an entity page.

Clause 21. A method comprising: receiving, without a submission of a user query, a model response from a large language model, the model response including structured data generated by the large language model using a plurality of security alerts; and rendering an interface on a computing device using the structured data, the interface displaying information about a security insight event detected by the large language model using the plurality of security alerts, the interface identifying a portion of the plurality of security alerts as related to the security insight event.

Clause 22. The method of clause 21, wherein the information about the security insight event includes at least one of a summary of the security insight event or a detailed description about the security insight event.

Clause 23. The method of clause 21 or 22, wherein the information about the security insight event includes an attack chain graphic with progression data.

Clause 24. The method of any one of clauses 21 to 23, wherein the information about the security insight event includes a selectable element associated with an entity, the method further comprising: receiving a selection to the selectable element; and in response to the selection of the selectable element, initiating a display of an entity interface with information about the entity.

Clause 25. The method of clause 24, wherein the entity includes a device identifier, a user identifier, a process identifier, or a file identifier.

Clause 26. The method of any one of clauses 21 to 25, wherein the interface includes a selectable control that enables a user to switch between an anonymized value and a non-anonymized value for an entity mentioned in the information about the security insight event, the method further comprising: receiving a section to the selectable control; and replacing the anonymized value with the non-anonymized value.

Clause 27. The method of any one of clauses 21 to 26, wherein the interface includes an action item associating with a case management system, the method further comprising: in response to selection of the action item, initiating display of a user interface for adding the security insight event to a case in the case management system; and transferring at least a portion of the information about the security insight event to the case in the case management system.

Clause 28. The method of any one of clauses 21 to 27, wherein the interface includes an action item for a chat interface, the method further comprising: in response to selection of the action item, initiating display of the chat interface; inserting at least a portion of the information about the security insight event into a prompt; and receiving a user query via an input field of the chat interface, the prompt including at least the portion of the information about the security insight event and the user query.

Clause 29. The method of any one of clauses 21 to 28, wherein the interface displays a menu with a plurality of large language model (LLM) identifiers including a first LLM identifier associated with a first LLM and a second LLM identifier associated with a second LLM, the method further comprising: receiving a selection to the second LLM identifier; and in response to the selection to the second LLM identifier, initiating generation of the model response using the second LLM.

Clause 30. An apparatus comprising: at least one processor; and a non-transitory computer-readable medium storing executable instructions that cause the at least one processor to execute operations, the operations comprising: receiving, without a submission of a user query, a model response from a large language model, the model response including structured data generated by the large language model using a plurality of security alerts; and rendering an interface on a computing device using the structured data, the interface displaying information about a security insight event detected by the large language model using the plurality of security alerts, the security insight event being a potential active attack on a monitored computing system, the interface identifying a portion of the plurality of security alerts as related to the security insight event.

Clause 31. The apparatus of clause 30, wherein the information about the security insight event includes at least one of a summary of the security insight event or a detailed description about the security insight event.

Clause 32. The apparatus of clause 30 or 31, wherein the information about the security insight event includes an attack chain graphic with progression data.

Clause 33. The apparatus of any one of clauses 30 to 32, wherein the information about the security insight event includes a selectable element associated with an entity, wherein the operations further comprise: receiving a selection to the selectable element; and in response to the selection of the selectable element, initiating a display of an entity interface with information about the entity, wherein the entity includes a device identifier, a user identifier, a process identifier, or a file identifier.

Clause 34. The apparatus of any one of clauses 30 to 33, wherein the interface includes a selectable control configured to switch between an anonymized value and a non-anonymized value for an entity mentioned in the information about the security insight event, wherein the operations further comprise: receiving a section to the selectable control; and replacing the anonymized value with the non-anonymized value.

Clause 35. The apparatus of any one of clauses 30 to 34, wherein the interface includes an action item associating with a case management system, wherein the operations further comprise: in response to selection of the action item, initiating display of a user interface for adding the security insight event to a case in the case management system; and transferring at least a portion of the information about the security insight event to the case in the case management system.

Clause 36. The apparatus of any one of clauses 30 to 35, wherein the interface includes an action item for a chat interface, wherein the operations further comprise: in response to selection of the action item, initiating display of the chat interface; inserting at least a portion of the information about the security insight event into a prompt; and receiving a user query via an input field of the chat interface, the prompt including at least the portion of the information about the security insight event and the user query.

Clause 37. The apparatus of any one of clauses 30 to 36, wherein the interface displays a menu with a plurality of large language model (LLM) identifiers including a first LLM identifier associated with a first LLM and a second LLM identifier associated with a second LLM, wherein the operations further comprise: receiving a selection to the second LLM identifier; and in response to the selection to the second LLM identifier, initiating generation of the model response using the second LLM.

Clause 38. A non-transitory computer-readable medium storing executable instructions that when executed by at least one processor cause the at least one processor to execute operations, the operations comprising: receiving, without a submission of a user query, a model response from a large language model, the model response including structured data generated by the large language model using a plurality of security alerts; and rendering an interface on a computing device using the structured data, the interface displaying information about a security insight event detected by the large language model using the plurality of security alerts, the security insight event being a potential active attack on a monitored computing system, the interface identifying a portion of the plurality of security alerts as related to the security insight event.

Clause 39. The non-transitory computer-readable medium of clause 38, wherein the interface includes an action item for a chat interface, wherein the operations further comprise: in response to selection of the action item, initiating display of the chat interface; inserting at least a portion of the information about the security insight event into a prompt; and receiving a user query via an input field of the chat interface, the prompt including at least the portion of the information about the security insight event and the user query.

Clause 40. The non-transitory computer-readable medium of clause 38 or 39, wherein the interface displays a menu with a plurality of large language model (LLM) identifiers including a first LLM identifier associated with a first LLM and a second LLM identifier associated with a second LLM, wherein the operations further comprise: receiving a selection to the second LLM identifier; and in response to the selection to the second LLM identifier, initiating generation of the model response using the second LLM.

Clause 41. A method comprising: initiating display of a user interface, the user interface identifying a first identifier of a first large language model (LLM) and a second identifier of a second LLM; receiving a selection of the first LLM; initiating generation of a first model response by the first LLM, the first model response including structured data about at least one first security insight event generated by the first LLM using a plurality of security alerts; storing the at least one first security insight event in a storage device; and rendering an interface based on the first model response, the interface displaying the at least one first security insight event.

Clause 42. The method of clause 41, further comprising: receiving a selection of the second LLM; initiating generation of a second model response by the second LLM, the second model response including structured data about at least one second security insight event generated by the second LLM using the plurality of security alerts; storing the at least one second security insight event in the storage device; and rendering the interface based on the second model response, the interface displaying the at least one second security insight event.

Clause 43. The method of clause 41 or 42, wherein the at least one first security insight event includes at least one of a summary of the at least one first security insight event or a detailed description about the at least one first security insight event.

Clause 44. The method of any one of clauses 41 to 43, wherein the at least one first security insight event includes an attack chain graphic with progression data.

Clause 45. The method of any one of clauses 41 to 44, wherein the at least one first security insight event includes a selectable element associated with an entity, the method further comprising: receiving a selection to the selectable element; and in response to the selection of the selectable element, initiating a display of an entity interface with information about the entity.

Clause 46. The method of clause 45, wherein the entity includes a device identifier, a user identifier, a process identifier, or a file identifier.

Clause 47. The method of any one of clauses 41 to 46, wherein the at least one first security insight event includes a selectable control configured to switch between an anonymized value and a non-anonymized value for an entity mentioned in the at least one first security insight event, the method further comprising: receiving a section to the selectable control; and replacing the anonymized value with the non-anonymized value.

Clause 48. The method of any one of clauses 41 to 47, wherein the at least one first security insight event includes an action item associating with a case management system, the method further comprising: in response to selection of the action item, initiating display of a user interface for adding the at least one first security insight event to a case in the case management system; and transferring at least a portion of the at least one first security insight event to the case in the case management system.

Clause 49. The method of any one of clauses 41 to 48, wherein the at least one first security insight event includes an action item for a chat interface, the method further comprising: in response to selection of the action item, initiating display of the chat interface; inserting at least a portion of the at least one first security insight event into a prompt; and receiving a user query via an input field of the chat interface, the prompt including at least the portion of the at least one first security insight event and the user query.

Clause 50. An apparatus comprising: at least one processor; and a non-transitory computer-readable medium storing executable instructions that cause the at least one processor to execute operations, the operations comprising: initiating display of a user interface, the user interface identifying a first identifier of a first large language model (LLM) and a second identifier of a second LLM; receiving a selection of the first LLM; initiating generation of a first model response by the first LLM, the first model response including structured data about at least one first security insight event generated by the first LLM using a plurality of security alerts; storing the at least one first security insight event in a storage device; and rendering an interface based on the first model response, the interface displaying the at least one first security insight event.

Clause 51. The apparatus of clause 50, wherein the operations further comprise: receiving a selection of the second LLM; initiating generation of a second model response by the second LLM, the second model response including structured data about at least one second security insight event generated by the second LLM using the plurality of security alerts; storing the at least one second security insight event in the storage device; and rendering the interface based on the second model response, the interface displaying the at least one second security insight event.

Clause 52. The apparatus of clause 50 or 51, wherein the operations further comprise: obtaining a first connector from a plurality of connectors, the plurality of connectors including the first connector and a second connector, the first connector being associated with the first LLM, the second connector being associated with the second LLM; and transmitting, using the first connector, the first model response to the first LLM.

Clause 53. The apparatus of any one of clauses 50 to 52, wherein the at least one first security insight event includes at least one of a summary of the at least one first security insight event or a detailed description about the at least one first security insight event.

Clause 54. The apparatus of any one of clauses 50 to 53, wherein the at least one first security insight event includes an attack chain graphic with progression data.

Clause 55. The apparatus of any one of clauses 50 to 54, wherein the at least one first security insight event includes a selectable element associated with an entity, wherein the operations further comprising: receiving a selection to the selectable element; and in response to the selection of the selectable element, initiating a display of an entity interface with information about the entity.

Clause 56. The apparatus of clause 55, wherein the entity includes a device identifier, a user identifier, a process identifier, or a file identifier.

Clause 57. The apparatus of clause 55, wherein the at least one first security insight event includes a selectable control configured to switch between an anonymized value and a non-anonymized value for an entity mentioned in the at least one first security insight event, wherein the operations further comprise: receiving a section to the selectable control; and replacing the anonymized value with the non-anonymized value.

Clause 58. A non-transitory computer-readable medium storing executable instructions that when executed by at least one processor cause the at least one processor to execute operations, the operations comprising: initiating display of a user interface, the user interface identifying a first identifier of a first large language model (LLM) and a second identifier of a second LLM; receiving a selection of the first LLM; initiating generation of a first model response by the first LLM, the first model response including structured data about at least one first security insight event generated by the first LLM using a plurality of security alerts; storing the at least one first security insight event in a storage device; and rendering an interface based on the first model response, the interface displaying the at least one first security insight event.

Clause 59. The non-transitory computer-readable medium of clause 58, wherein the operations further comprise: receiving a selection of the second LLM; initiating generation of a second model response by the second LLM, the second model response including structured data about at least one second security insight event generated by the second LLM using the plurality of security alerts; storing the at least one second security insight event in the storage device; and rendering the interface based on the second model response, the interface displaying the at least one second security insight event.

Clause 60. The non-transitory computer-readable medium of clause 58 or 59, wherein the at least one first security insight event includes at least one of a summary of the at least one first security insight event or a detailed description about the at least one first security insight event, wherein the at least one first security insight event includes an attack chain graphic with progression data.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are remote from each other and typically interact through a communication network. The relationship of client and server arises by virtue of computer programs running on the respective computers and having a client-server relationship with each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device. Moreover, no item or component is essential to the practice of the implementations disclosed herein unless the element is specifically described as “essential” or “critical”.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although certain example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

What is claimed is:

1. A method comprising:
retrieving a plurality of security alerts from a database;
transmitting a prompt to a large language model, the prompt including formatting instructions and the plurality of security alerts;
receiving a model response from the large language model, the model response including structured data configured to render an interface, the structured data including information about a security insight event detected by the large language model using the plurality of security alerts, the structured data identifying a portion of the plurality of security alerts as related to the security insight event; and
transmitting the model response to application, the model response being to cause the application to render the interface.

2. The method of claim 1, further comprising:
generating anonymized security alerts from the plurality of security alerts by converting a non-anonymized value of an entity mentioned in a security alert to an anonymized value, wherein the anonymized security alerts are included in the prompt.

3. The method of claim 1, wherein the plurality of security alerts retrieved from the database include a first format, the method further comprising:
converting the plurality of security alerts from the first format to a second format, the plurality of security alerts with the second format being included in the prompt.

4. The method of claim 1, further comprising:
determining whether the model response achieves a formatting structure defined by the formatting instructions; and
in response to the model response being determined as achieving the formatting structure defined by the formatting instructions, transmitting the model response to the application.

5. The method of claim 1, wherein the structured data defines a computer object for the security insight event, the computer object configured to be expanded or collapsed.

6. The method of claim 5, wherein the computer object includes a selectable element of an entity mentioned in the security insight event, the selectable element, when selected, configured to render an entity page.

7. The method of claim 1, further comprising:
receiving a selection of an identifier associated with the large language model;
obtaining a connector that corresponds to the identifier associated with the large language model; and
transmitting the prompt using the connector.

8. The method of claim 7, wherein the large language model is a first large language model and the connector is a first connector, the method further comprising:
receiving a selection of an identifier associated with a second large language model;
obtaining a second connector that corresponds to the identifier associated with the second large language model; and
transmitting the prompt using the second connector.

9. An apparatus comprising:
at least one processor; and
a non-transitory computer-readable medium storing executable instructions that cause the at least one processor to execute operations, the operations comprising:
retrieving a plurality of security alerts from a database;
transmitting a prompt to a large language model, the prompt including formatting instructions and the plurality of security alerts;
receiving a model response from the large language model, the model response including structured data configured to render an interface, the structured data including information about a security insight event detected by the large language model using the plurality of security alerts, the structured data identifying a portion of the plurality of security alerts as related to the security insight event; and
transmitting the model response to application, the model response being to cause the application to render the interface.

10. The apparatus of claim 9, wherein the operations further comprise:
generating anonymized security alerts from the plurality of security alerts by converting a non-anonymized value of an entity mentioned in a security alert to an anonymized value, wherein the anonymized security alerts are included in the prompt.

11. The apparatus of claim 9, wherein the plurality of security alerts retrieved from the database include a first format, wherein the operations further comprise:
converting the plurality of security alerts from the first format to a second format, the plurality of security alerts with the second format being included in the prompt.

12. The apparatus of claim 9, wherein the operations further comprise:
determining whether the model response achieves a formatting structure defined by the formatting instructions; and
in response to the model response being determined as achieving the formatting structure defined by the formatting instructions, transmitting the model response to the application.

13. The apparatus of claim 9, wherein the structured data defines a computer object for the security insight event, the computer object configured to be expanded or collapsed, wherein the computer object includes a selectable element of an entity mentioned in the security insight event, the selectable element, when selected, configured to render an entity page.

14. The apparatus of claim 9, wherein the operations further comprise:
receiving a selection of an identifier associated with the large language model;
obtaining a connector that corresponds to the identifier associated with the large language model; and
transmitting the prompt using the connector.

15. The apparatus of claim 14, wherein the large language model is a first large language model and the connector is a first connector, wherein the operations further comprise:
receiving a selection of an identifier associated with a second large language model;
obtaining a second connector that corresponds to the identifier associated with the second large language model; and
transmitting the prompt using the second connector.

16. A non-transitory computer-readable medium storing executable instructions that when executed by at least one processor cause the at least one processor to execute operations, the operations further comprising:
retrieving a plurality of security alerts from a database;
transmitting a prompt to a large language model, the prompt including formatting instructions and the plurality of security alerts;
receiving a model response from the large language model, the model response including structured data configured to render an interface, the structured data including information about a security insight event detected by the large language model using the plurality of security alerts, the structured data identifying a portion of the plurality of security alerts as related to the security insight event; and
transmitting the model response to application, the model response being to cause the application to render the interface.

17. The non-transitory computer-readable medium of claim 16, wherein the operations further comprise:
generating anonymized security alerts from the plurality of security alerts by converting a non-anonymized value of an entity mentioned in a security alert to an anonymized value, wherein the anonymized security alerts are included in the prompt.

18. The non-transitory computer-readable medium of claim 16, wherein the plurality of security alerts retrieved from the database include a first format, wherein the operations further comprise:
converting the plurality of security alerts from the first format to a second format, the plurality of security alerts with the second format being included in the prompt.

19. The non-transitory computer-readable medium of claim 16, wherein the operations further comprise:
determining whether the model response achieves a formatting structure defined by the formatting instructions; and
in response to the model response being determined as achieving the formatting structure defined by the formatting instructions, transmitting the model response to the application.

20. The non-transitory computer-readable medium of claim 16, wherein the structured data defines a computer object for the security insight event, the computer object configured to be expanded or collapsed, wherein the computer object includes a selectable element of an entity mentioned in the security insight event, the selectable element, when selected, configured to render an entity page.
